(19) United States
(12) Patent Application Publication
(10) Pub. No.: US 2009/0192952 A1
(43) Pub. Date: Jul. 30, 2009

(54) Healthcare Advocacy Program

(76) Inventor: Kevin Flynn, Philadelphia, PA (US)

Correspondence Address: BLANK ROME LLP, ONE LOGAN SQUARE, PHILADELPHIA, PA, 19103, US

(21) Appl. No.: 12/358,500

(22) Filed: Jan. 23, 2009

Related U.S. Application Data
(62) Division of application No. 10/054,762, filed on Jan. 22, 2002, now abandoned.
(60) Provisional application No. 60/263,152, filed on Jan. 22, 2001.
(60) Provisional application No. 60/294,289, filed on May 31, 2001.

(51) Int. Cl. G06Q 90/00

(52) U.S. Cl. 705/500

(57) ABSTRACT

The present invention is a Healthcare Advocacy Program (HAP) that handles financial and administrative issues in healthcare for patients, providers, medical producers, employees and employers. The program advocates for treatment across a total continuum of healthcare, ensuring that proper treatment is provided, that payment for treatment is made, and that proper reimbursements by the payor occur. The program can be used by medical producers to ensure that their products can be obtained; by providers when appealing an MCO denial; by collection companies and by companies that purchase debt; and by employers wishing to have a positive effect on their bottom line.

### RELATED APPLICATIONS

This application is a division of U.S. application Ser. No. 10/054,762, filed Jan. 22, 2002, entitled “A Healthcare Advocacy Program;” which application claims priority under 35 USC § 119(e) to: 1) U.S. Provisional Patent Application Ser. No. 60/263,152, filed Jan. 22, 2001, entitled “Treatment and Financial Assurance System for Patients and Providers;” 2) U.S. Provisional Patent Application Ser. No. 60/294,289, filed May 31, 2001, entitled “Treatment and Financial Reimbursement System.” The above related applications are incorporated herein by reference.

### FIELD OF THE INVENTION

The present invention relates generally to healthcare advocacy, and more particularly to the handling of financial and administrative matters relating to healthcare to provide financial assurance to employees, employers, patients, providers, and medical producers.

### TERMS

Healthcare Advocacy Program (HAP), the present invention
Treatment (treatment, surgery, nursing home, home health, ambulatory services, medication(s), medical equipment, hospital stay, skill level change, long-term care, short-term care, rehabilitation, etc.)
Payor (health insurance, third party administrators-ERISA plans, Medicare, Medicaid, SSI, workers' compensation plan, Cancer policies, disability policies, pension funds, personal injury protection plan (PIP coverage), and other entities that are financially responsible)
Grievance/Appeal (grievance, appeal or process to resolve a dispute)
Denial (when the payor refuses coverage for treatment, medication, medical devices, higher skill level, care, benefits, etc.)
Provider (doctor, hospital, physical therapist, occupational therapist, MSW, LSW, Ph.D., RN, PA, NP or other licensed health professional)
Church (church, synagogue, mosque, religious organization or charitable organization)
TPA (third party administrator)
Member, enrollee and patient are synonymous.
MCO (managed care organization. Example: an HMO, POS, PPO, etc. health plan).
Medical Producer (a drug company, laboratory testing company, medical equipment company or other health related product).
UCR (usual and customary rate. An insurer's reimbursement schedule.)
Utilization Review (in hospital the Utilization Review (UR) department generally handles denials. In physician offices the doctor or a staff member generally handles denials. For simplicity, we will refer to the party that handles denials as the UR department).
HIPAA (Federal law, the Health Insurance Portability and Accountability Act.)
Corporate Compliance (the Office of Inspector General's compliance standard's for fraud and abuse).
Alternative Disputes Resolution System: an appeals process available to providers by the payors that is separate from the formal appeal/grievance process. An example of this is Pennsylvania's Informal/Alternative Disputes Resolutions System under ACT 68.
Database (in this document we make mention of an SQL database and a FoxPro database. Most computerized databases such as Oracle, MS SQL Server, FoxPro, SyBase, flat file database, MS Access, etc., may be used in place of the SQL and FoxPro databases.)
Self-insured plan (a health plan that operates under ERISA)

### BACKGROUND OF THE INVENTION

Employers are always seeking ways to reduce costs and increase employee productivity. One situation negatively effecting employee productivity is when the employee, or a family member, has a health-related problem. An example of such a problem is if a family member develops cancer. What generally happens in these situations is various family members spend time on the phone, while at work, locating the best physician, scheduling provider appointments, submitting and chasing claim forms, worrying about the family member's care and more. These situations cause the employee to spend countless hours addressing healthcare related issues and not working. Furthermore, when the employee is working, it is at a reduced level because the employee's mind is focused on other issues and he/she cannot concentrate. To that end, the services of the present invention (HAP) cares for all of the employees' needs, allowing the employee to concentrate on their work, and not on their medical issues.

The present invention (HAP) is an entity providing healthcare related services to its members. By having expertise in medicine, business, law and other areas, HAP can answer a member's question and guide them to resolving the problem in a much more effective and timely manner. Furthermore, by having an expert at their fingertips, the employee's/member's stress will be reduced knowing that all is well. As a result, the employee's issues are addressed allowing them to work productively and not use the employer's resources to solve their medical matters, thereby increasing the employer's bottom line.

Sales brokers and insurance companies concentrate on sales. While they spend a lot of time on sales, they seldom seek ways to increase their bottom line by lowering attrition. The problem here is that the sales brokers and insurance companies do not have enough contact with the members and employers to know if the employers and employees are happy. To that end, HAP can act as a customer satisfaction monitor thereby alerting the insurance company or sales broker of possible complications prior to the complications becoming a problem. For these reasons, the services of HAP may also be used as a sales incentive tool (for insurance products including life, health, disability, etc).

Employers with less than six employees do not have to offer health insurance to their employees. And, even if the employer does offer health insurance to their employees, the employee is still subject to the decisions made by their health insurance carrier. To that end, and to protect both the employer and employee's interests, HAP developed a methodology to ensure treatment and/or coverage.

Prior to the implementation and growth of Managed Care Organizations (MCOs), pre-authorization for medical treatment was not needed and denials for coverage of care were generally limited to situations of unnecessary treatment, experimental treatment and/or elective surgery.

With the advent of MCOs came pre-authorizations, denials, care level issues, formularies and more. What occurred was the insurer would approve or deny coverage for treatment, care levels, medications and more, that a physician would prescribe prior to, during and sometimes after a procedure (retroactive denial). To complicate matters further, MCOs often write into their provider contracts that the provider may not bill the patient for treatment that is rendered if the MCO felt the treatment was/is not medically necessary. While providers will generally use their rights (i.e. NCQA regulations, Pennsylvania's ACT 68 statute, etc) to appeal the denials, their efforts are often unsuccessful. Because of that, the patient must go without proper care, pay for the care out-of-pocket, or the provider(s) must incur the charges.

To deal with authorization and denials issues, different organizations took different approaches:

### Lawyers

Lawyers sued MCOs claming that the MCOs were in-fact practicing medicine when it approved or denied coverage for treatment. Lawyers also sued in cases where a patient encountered a detrimental outcome due to the MCOs denial of coverage, treatment by a less qualified physician, time delays when re-routing a patient to an MCO approved treatment facility or other.

While the lawyers' approach might result in a monetary settlement, the problems are: 1) the person must be injured before a lawsuit may be filed; 2) a lot of states do not allow patients to sue their MCOs due to protections offered by federal law; and 3) if a person were to sue for care, the legal bills would often be greater than the cost of the medical care.

HAP solves this problem by advocating for individuals prior to, during, and after their period of need in a cost-effective manor using existing laws, regulations, contracts, policies and more. The end result is that the patient obtains the care, avoiding the potential harm from denials, re-routing, less qualified physicians, etc.

### Providers

Providers combat denials by arguing medical facts with the MCO's representative and using the alternative/informal dispute resolution system. Unfortunately, the providers' approach in overturning authorization and denials are not always effective. Part of the problem that providers have is that when they advocate for the patient, they deeds are often perceived as self-serving. Also, providers have limited abilities to advocate. While certain guidelines exist, such as Milliman and Robertson, InterQual and others, and most states have legislation, such as Pennsylvania's Act 68, which allows providers to advocate for the patient, providers are still limited in their abilities to advocate and do not have the same rights, in advocating, as the patient.

Another problem providers face is accountability. If an MCO refuses to cover the cost of treatment based on the fact that it is not medically necessary, then there is nothing else the provider can do. While some providers sue based on a “pattern” of denials, there is nothing they can do on an individual basis or for the claims that lay outside the scope of the “pattern.”

Also, providers often enter into contracts with payors that inhibit the provider and the patient (as illustrated in FIGS. 5a and 5b). An example is Tagamet IV, used to help patients avoid post-operative nausea and vomiting. Often, Tagamet IV cannot be prescribed because a doctor or hospital previously entered into a contract with an MCO that does not have Tagamet IV on the formulary. While the provider can request that Tagamet IV be covered, the doctor is bound by the contract that he and/or the hospital signed with the MCO. In this situation, the methodology of the present invention (i.e., advocating on behalf of the individual patient) may overcome this obstacle because the patient never entered into the provider/MCO contract.

When providers appeal they almost always use the informal/alternative dispute resolution system. The problem with this system is that it does not create accountability for the MCO when the MCO denies treatment. While providers appeal denials, they do so primarily based on medical facts alone. Seldom does one see a provider's appeal, which includes the legal ramifications of the appeal.

Another problem with providers is timing. For example, it is determined by an MCO that a patient is to be discharged the next day to a skilled nursing facility. The treating doctor wants the patient to go to an acute rehabilitation facility. While the treating doctor can appeal the decision, the doctor will come under a lot of pressure from the hospital to discharge the patient to the skilled nursing facility because the hospital will be forced to absorb the cost of the care while the doctor appeals the decision. Also, if the doctor asks the hospital's UR department to appeal the MCO decision, how much time will be given to the appeal when the outcome of the appeal benefits another facility? In these situations, the patient generally is discharged to a skilled nursing facility because there is not enough time to appeal the decision and because it is in the hospital's financial best interest to discharge the patient regardless of the facility the patient will be sent to.

The present invention (HAP) overcomes the problem of authorization and denials by beginning its own campaign. HAP, representing the patient and using the patient's rights, is not bound by the contract between the provider(s) and the MCO. Hence, HAP can advocate in a more effective manner. Furthermore, utilizing HAP's methodology for advocating causes accountability for the payor in many different venues. Finally, HAP does not use the informal, alternative dispute resolution process, so the payor must treat the appeal with greater scrutiny.

### The American Medical Association (AMA)

The AMA's approach is to lobby government agencies into passing legislation that would put accountability and controls on MCOs. While the AMA's approach is admirable, HAP attacks cases one at a time. Also, HAP attacks the source of the problem, the individual denial; the AMA fails to attack the denial and instead lobbies for reform.

### Patient Advocates

Hospitals have patient advocates, but they do not address denial issues. There are private sector patient advocates who handle authorization and denial issues; however, these advocates fall into one of two categories: 1) a former healthcare provider; or 2) an attorney. Based on their background, they will appeal the denial based on the Providers' methodology (as discussed in the Providers' section), by acting as an ombudsman, or by the legal methodology also previously discussed. There are also occasions where the private sector advocate will educate the patient on the appeals process.

Private sector patient advocates are great; however they often are not successful because: 1) they cannot generate enough income to stay in business; 2) they face the same problems that providers and lawyers do when they approach problems in the same manner as providers and lawyers; or 3) they do not have a membership following to give their organization credibility.

HAP overcomes the problems faced by the private sector advocates by: 1) contracting with providers, employers and others to ensure income; 2) using a multi-disciplinary approach to overturn denials; 3) being a membership organization, thereby speaking for many (not just one); and 4) contracting with employers to gain leverage with payors, as the membership can bias employers to a certain selection of health insurance company.

### Advocating for One's Self

Advocating for one's self is an admirable venture, but success is difficult. It is reported that most patients abandon their appeal after a first level review. Because the layperson is generally not trained in medicine, law, the appeals process, or on the best way to appeal a denial, self-advocators often fail.

Often, the layperson does not understand that they have been denied care. One example is a “denied care level”. In this situation, the payor will deny coverage for a higher quality of care. Because the layperson is generally not educated in medicine, they will not understand the effect of the denial, and hence will not appeal the decision.

For example, Paul is a 70-year old man who suffered a stroke. Paul's doctor wanted him to go to a rehabilitation hospital but Paul's MCO would only approve a skilled nursing facility. Not knowing the difference, Paul was ready to accept the skilled nursing facility. Due to the differences in care offered at the two facilities, the result would have been Paul's ability to leave the facility walking on his own as opposed to walking with the help of a walker.

HAP overcomes these problems by presenting medical information, legal issues, ethical issues, contractual issues, and by understanding the extent of the denial, and its effects on the patient. Furthermore, because a contract between HAP and a patient allows a provider to contact HAP on behalf of the patient, HAP will be alerted to a care level or other denial that could affect patient outcome. HAP then has the expertise to understand the potential result of the denial, and will proceed to handle the denial.

### Collection Agencies

Collection agencies have long solicited payment from insurers and patients to satisfy patient bills. They do this by submitting claims to the insurer or patient and if unsuccessful, sometimes refer the case to an attorney for legal action against the patient.

Though collection agencies solicit payment, they do so after the patient has received care and only address the charges deemed acceptable (i.e. if the MCO's contract does not allow the provider to seek reimbursement from the patient, the collection companies cannot solicit payment for the treatment in question. Also, if pre-authorization was not given, they cannot collect).

HAP goes beyond the scope of a collection agency by seeking authorization for coverage prior to treatment, and by having denials reversed retroactively, thereby avoiding the need for a collection agency. HAP seeks authorization for treatment and reimbursement for both covered services and for services for which the hospital is not allowed to charge (in accordance with the MCO contract). Combining the methods of the present invention with traditional collections practice, and with bill and reimbursement auditing, provides a complete financial solution to the entire healthcare process (i.e, from prescribing treatment, through billing and collections, including auditing physician reimbursement from the insurer to ensure proper reimbursement).

### Specific Goal Versus Total Coverage Across the Continuum

While patient advocates and doctors have tried to assist patients, their efforts have always been directed to a specific goal. HAP's implementation is directed to ensuring coverage for treatment, ensuring payment for treatment and ensuring proper reimbursement by the payor across the total continuum of care. For example, a patient is in the hospital recovering from an automobile accident. The patient's doctor wants him to go to an acute rehabilitation hospital. The MCO will only approve a skilled nursing facility and demands the patient be discharged immediately. Because the hospital must now absorb the cost for every day the patient remains in the hospital from this day forward, and because the hospital does not have the time to wait to exhaust every stage of the appeal process, the hospital will discharge the patient to the skilled nursing facility, where the patient receives less treatment than the provider deemed necessary. Ensuring total coverage across the continuum of care includes not only assuring treatment and payment for treatment, but for assuring that degree and extent of the treatment prescribed is provided.

### SUMMARY OF THE INVENTION

The present invention is a Healthcare Advocacy Program (HAP) that handles financial and administrative issues in healthcare for patients, providers, medical producers, employees and employers. The program advocates for treatment across a total continuum of healthcare, ensuring that proper treatment is provided, that payment for treatment is made, and that proper reimbursements by the payor occur. The program can be used by medical producers to ensure that their products can be obtained; by providers when appealing an MCO denial; by collection companies and by companies that purchase debt; and by employers wishing to have a positive effect on their bottom line.

HAP assures proper treatment through the continuum of care by:

### Notification

HAP notifies, by letter, a Managed Care Organization (MCO) and describes consequences to a patient if the MCO were to deny care. Through notification, HAP has bound the MCO to liability in the event an adverse outcome or reaction results from the denial. The patient can then sue the MCO because HAP has established liability through notification. This activity settles any legal premise that the MCO had to be informed, to be liable, that an adverse reaction could occur if the requested treatment was not provided. Since provider interactions tend to be by telephone only, and such conversations are rarely noted in the patient's medical record, HAP's activity establishes proper notification.

### Confidence

By advocating for the patient, HAP provides the patient with peace of mind, the patient knowing that someone is on his side. Too often patients are intimidated by the medical bureaucracy and fear speaking up for themselves. HAP overcomes that the fear, reducing patient stress and providing peace of mind.

### Conversion

Another way HAP is successful is through conversion. While insurers have used conversion, at their discretion, to cover treatment (after treatment was provided), no entity has used conversion as a negotiating tool to obtain treatment (before treatment is provided). An example of conversion is negotiating two out-patient psychology visits for every unused in-patient day the member is allowed.

### Patient Engages and is Responsible for HAP

One embodiment of the present invention has the patient paying for HAP services on behalf of himself and the provider. In an authorization and payment plan (A&P Plan), the patient engages HAP for advocacy services, prior to incident, and is thereafter covered. While the patient is covered, the provider is inherently covered as well, because protecting the patient requires that HAP assures that the insurer pays the provider. In this embodiment of the invention, the provider's interests are aligned with the patient's. In other embodiments, the provider engages HAP with either an up-front or contingency fee arrangement.

Based on how the A&P Plan is set up, the patient has paid for part or all of the collections fees. Traditionally, collection fees are based on a percentage of the fees collected for the provider, and that percentage is paid by the provider. With the A&P Plan, the patient pays for all, or part, of the collection fees.

### Physician Reimbursement

HAP also advocates for higher physician reimbursement. While payment guidelines are agreed upon when a provider becomes a participant of an MCO, HAP can advocate for an increase in physician reimbursement for specific provider treatments even after the provider has contracted with an insurer.

### Third Party Advocate for Provider

HAP is believed to be the first third party entity to advocate on behalf of a provider to overturn denials. While advocates have represented individual patients, currently no advocate exists for the provider.

### Total Financial Package for Providers and Patients

HAP is believed to be the only entity handling all of the financial issues (authorization, payment, collections and auditing) of healthcare across the entire continuum of care.

### Capitated Environment

If capitated, HAP can obtain additional monies because the capitation is between the provider and the payor, the patient did not enter into the payor-provider agreement. Hence, HAP can get additional monies for treatment because the patient is not bound by the agreement.

### Multi Disciplinary Approach to Advocacy

HAP employs a multidisciplinary approach to advocating. Physicians use medical facts when advocating. Lawyers use the law when advocating. Advocates use the grievance system when advocating. HAP is the only organization that uses a multi-disciplinary approach to healthcare advocacy, including medicine, law, economics, business style leverage, intangible leverage, public relation campaigns, and the force of a united membership.

### Reimbursement Auditing

The auditing of provider reimbursements from insurers is known. While this practice is sound for reimbursement, it is limited to a specific niche and does not complement the other financial parts of a provider's financial needs.

HAP provides a single, seamless financial solution for providers. HAP provides solutions across the continuum of healthcare, protecting both the provider and the patient, as many of the provider's interests overlap the patient's interests.

### Buying Debt

While some companies buy debt and try to collect on it, companies do not buy debt that has accrued due to healthcare coverage denials, because once the provider has exhausted their rights, there is no other recourse other than suing based on a “pattern of denials”. Furthermore, unless the appropriate legal language is included in the providers' registration forms, the provider will be in violation of HIPPA regulations. HAP is successful by having the provider obtain consent for HAP to re-open each case on behalf of the patient. Once consent is given, HAP may then buy the debt and employ HAP's healthcare advocacy methods to recover debt.

Benefits to Employers & Employees by the Health Advocacy Services of the Present Invention: Below is an outline of how HAP benefits various healthcare related personnel and matters:

### Health Counselor

### Employer:

1) Saves the Human Resources Department time by answering questions and directing employees. 2) Provides assurance and answers questions for employees allowing them to concentrate on their jobs and not their problems. 3) HAP is tax deductible.

### Employee:

1) Helps employees find the resources they need. 2) Helps employees understand the “process.” 3) Helps answer employees' questions and problems. 4) Is a starting point for problem resolution. 5) Provides support and guidance. 6) Helps to relieve stress associated with the “process.”

### Healthcare Provider & Facility Finder

### Employer:

1) Reduces “down time” and absences at work. HAP locates healthcare providers and facilities, relieving the employee of this burden. This also reduces the employer's phone bill. 2) Minimizes employees' time off work by potentially reducing unnecessary and/or improper care. 3) Employees can avoid unnecessary and/or improper treatment, thus saving self-insured companies money. 4) Can reduce personnel costs associated with unnecessary absences (salary, temps, backlogs, over-time, etc.). 5) Tax deductible. 6) Builds good will with employees.

### Employee:

1) Helps employees find the best providers and facilities, potentially avoiding improper and/or unnecessary treatments. 2) Great benefit for employees who have been relocated. 3) Helps relieve stress and allows employees to concentrate on their jobs.

### Bills & Forms Service

### Employer:

1) Employees often perform personal, healthcare related tasks while at work. HAP will perform the task, allowing employees to concentrate on their jobs. 2) This service reduces the complaints the Human Resources Department receives allowing them to work. 3) Tax deductible.

### Employee:

1) Employees often perform personal, healthcare related tasks while at work. Even if the employees are enrolled in an HMO, they often take care of family member's Medicare bills. By having HAP take care of the paperwork, employees can concentrate on their jobs.

### Medical Research

### Employer:

1) Employees can remain working knowing they will have the information they need shortly. 2) Absences and related costs (salaries, temps, backlogs, over-time, etc.) can be reduced. 3) Doctor's visits and unnecessary/improper care can be reduced, thereby avoiding extended employee absences. 4) When inappropriate or unnecessary treatment is reduced, insurance companies save money and employer's insurance costs may be reduced. 5) Phone costs decline as employees are not searching for healthcare related information at work. 6) Peace of mind allows employees to concentrate on their jobs. 7) Tax deductible.

### Employee:

1) Feels empowered and has peace of mind knowing healthcare information is available.
2) Relieves stress.

### Nursing Home Assistance

### Employer:

1) Reduces phone calls made by employees. 2) Reduces employees' “down time” and absences while they search for answers. 3) Allows employees to concentrate on their jobs. 4) Tax deductible. 5) Builds good will with employees.

### Employee:

1) Helps employees understand how to pay for a nursing home. 2) Provides families with support at a difficult time. 3) Helps employees select a facility and avoid substandard facilities. 4) Helps employees to understand the patient's rights. 5) Helps employees find their way through the Medicare maze.

### Insurance Disputes Service

### Employer:

1) This service can act as the employer's Quality Assurance Department and ensure that employees are given the care they deserve. 2) Often insurance companies are penny-wise and pound-foolish. HAP saves insurance companies money by fighting for a $2,500 treatment that prevents a $20,000+operation(s). 3) Tax deductible. 4) Builds good will with employees.

### Employee:

1) Allows employees to gain access to treatment. 2) Affords employees the ability to question the insurance company's denial without the expense of hiring an attorney. 3) Increases employees' satisfaction with the health plan (the employees are being heard).

### Literature

### Employer:

1) Saves Human Resources Department time by answering questions. 2) Helps the employer meet federal and state guidelines with regard to notice to employees. 3) Tax deductible. 4) Builds good will with the employee.

### Employee:

1) Empowers employees during the course of treatment. 2) Easy reference guides.

### Negotiating a Provider's Bill

### Employer:

1) Reduces “down time” and absences at work. HAP takes the burden of handling the situation off the member. 2) Builds good will with employees. 3) Allows the employees to make well-informed medical decisions minimizing the costs of ERISA, Defined Contribution health plans and/or any plan that places financial decisions for medical care on the employee.

### Employee:

1) Helps employees stay financially sovereign and not declare bankruptcy. 2) Helps relieve stress and allows employees to concentrate on their job, not the problem. 3) Provides employees who are covered under defined contribution plans, or any other plan, a cost-effective way to make medical decisions.
An Illustration of Employer Savings through HAP's Services:

Employers cannot afford to be without HAP's services. Our services save employers money. This is accomplished by solving employees' health needs, allowing them to work and not concentrate on their, or their family's, health problems. In short, HAP will do the work while the employee concentrates on his/her job.

Table 1, below, indicates the cost of employee sick days, to the employer, and the potential savings through use of HAP's services, considering that HAP can reduce the number of employee sick days used. The chart does not indicate the additional costs of hiring temporary personnel, backlogs, etc.

TABLE 1
# of Sick Days & Cost to Employer

| # of | Avg. # of | Total # | Total Payout | Cost due |
|---|---|---|---|---|
| Employ- | sick days | of sick | from sick days | to sick |
| ees | (per employee) | days | ($30k salary) | days |
| 100 | 9.5 | 950 | $109,615 | $109,615 |
| 200 | 9.5 | 1900 | $219,231 | $219,231 |
| 500 | 9.5 | 4750 | $548,077 | $548,077 |
| 1000 | 9.5 | 9500 | $1,096,154 | $1,096,154 |
| 5000 | 9.5 | 47500 | $5,480,769 | $5,480,769 |

| # of | less 1/2 of | 1 less sick | 2 less sick | 3 less sick |
|---|---|---|---|---|
| employ- | a sick day | day per | days per | days per |
| ees | per employee | employee | employee | employee |
| 100 | $5,769 | $11,538 | $23,077 | $34,615 |
| 200 | $11,538 | $23,077 | $46,154 | $69,231 |
| 500 | $28,846 | $57,692 | $115,385 | $173,077 |
| 1000 | $57,692 | $115,385 | $230,769 | $346,154 |
| 5000 | $288,462 | $576,923 | $1,153,846 | $1,730,769 |

* Source, Bureau of Labor Statistics, 1996

Individual Examples of HAP's services:

Gerald, a 38-year-old man, had lower GI surgery. After the surgery, Gerald's intestine did not heal, causing bleeding and infection. He was seen by five doctor's, none of whom knew how to cure the problem. Through HAP's Doctor Finder Service, a GI specialist was found who successfully treated Gerald's problem. Gerald is now fine.

Gerald missed five days of work and spent countless hours on the phone seeking medical advice and referrals. Had Gerald simply contacted HAP at the beginning of his search, Gerald would have been better faster and his employer would not have incurred additional costs from his absences.

Other examples of situations like these include cancer, finding a nursing home for ones parents, heart disease, billing errors, etc.

The example above can also help self-insured (ERISA) companies save money. This is accomplished by ensuring that the patient gets to the best providers. It is well known that some providers will operate in situations where an operation may not be needed. By ensuring that a patient is seen by a well matched (matched for the particular problem) provider, the self-insured company is avoiding possible expenditures that may not otherwise be needed.

Employers have another reason to offer HAP's services. With employers shifting cost containment to the employee in the way of financial incentives and disincentives (defined contribution plans), HAP provides the employee with a tool that allows the member to make well-informed decisions and ensure quality.

For example, a defined contribution fund gives its employee $2,000 a month to care for all of their healthcare needs including doctor visits, prescriptions and more. The employee then develops an allergy. The question the employee asks himself is, do I go to my primary care physician for $50 and get the latest pill, or do I go to the allergist for $200 and get a full work-up?

HAP offers many advantages in these situations. First, HAP can provide the employee/patient with outcome results (medical information) allowing him/her to make an economically and scientifically informed decision whether to start with the primary care doctor or the allergist. Second, HAP can then negotiate a set of bundled services for the employee/patient, thereby keeping the cost down.

Another area in which HAP works well is with managed care companies (HMOs). HAP integrates well here because the NCQA requires a quality assurance program which HAP can supply; HAP also increases an MCO's member satisfaction by resolving the member's problem or by at least addressing the issue.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a flowchart illustrating how Healthcare Advocacy Program (HAP) services are implemented with employers, in accordance with the present invention;

FIG. 2 is a flowchart illustrating advocacy methods of the present invention;

FIG. 3 is a flowchart illustrating how HAP's advocacy methods and an Authorization and Payment Plan (A&P Plan) are implemented for providers, in accordance with the present invention;

FIG. 4 is a flowchart illustrating how HAP's services are implemented for medical producers, in accordance with the present invention;

FIG. 5a is a flowchart illustrating that providers are inhibited by MCO contracts and regulations when attempting to overturn denials and obtain authorizations and payments;

FIG. 5b is a flowchart illustrating that HAP is not inhibited by MCO contracts and regulations when attempting to overturn denials and obtain authorizations and payments;

FIG. 6a is a flowchart illustrating the steps performed by providers when collecting money; and

FIG. 6b is a flowchart illustrating the steps performed by providers to obtain authorizations and payments and to overturn denials.

### DETAILED DESCRIPTION OF THE INVENTION

### Section I—Contracting with a Sales Broker or an Insurance Company

A sales broker/insurance company utilizes a lot of time and resources getting in front of a client (a client being an employer or layperson) to make a sale. Therefore, one must ask himself/herself a few questions. They are 1) how do I maximize my return on the investment (the investment being the time and resources used to obtain and have a meeting with a client)? 2) Are there any benefits that the sales person can utilize to ensure that the client will purchase a product/service from him/her instead of a competitor? 3) How do I lower attrition, and increase quality assurance and customer satisfaction?

The answers to the above questions are: 1) Since the broker/insurance company has already made the investment in meeting with the client, the broker/insurance company could benefit from ancillary services/products available to sell to the client. 2) If a sales broker/insurance company is competing against another broker/company for the same sale, the broker/company can include HAP's service(s) as an incentive to purchase the product from the broker/company instead of the competitor. And in cases where a broker's/insurance company's product is inferior to a competitor's, HAP's services may be used to compensate for the disadvantage. 3) A broker/insurance company is enrolling 100 new companies every month. The question is, how many companies is it losing every month and why? A broker's/insurance company's sales cycle includes enrolling a new client then meeting with them a year later to renew the contract. During the year, The broker/insurance company representative doesn't have any interaction with the client and therefore doesn't know if its clients are satisfied or not. The irony is that if there is a problem, The broker/insurance company will probably never know because benefits managers generally changes companies rather than address the issues.

HAP will act as the quality assurance department that every broker/insurance company needs. It can increase customer satisfaction by meeting the needs of the employers and employees. Furthermore, HAP will inform the broker/insurance company of any problems the client has in order to remedy a situation before any adverse events occur.

The methodology would work like this: HAP would sign a contract with an insurance broker/insurance company, or a sales broker, to sell HAP's service. The broker/insurance company would then sell HAP's services to their clients. The client would then pay premiums to HAP, as indicated in the contract, for the services described in section V. The broker/insurance company would then be paid, on a pre-determined time period (e.g. monthly), a percentage of the premiums received from the clients to which they sold HAP's service(s).

### Section II—Selling to the Public

The methodology for selling to the public is: the person would sign a contract with HAP. The person would then pay their premiums as described in the contract (e.g. monthly, annually, hourly, per service, etc.). In exchange for payment, the person would receive the services described in section V.

### Section III—Selling to Employers

Whether HAP sells directly to an employer or through a broker or an insurance company, the methodology will be the same: the employer will sign a contract with HAP whereby the employer's employees will receive the services descried in section V. The employer would then pay premiums to HAP, as indicated in the contract, for the services. The employer may either pay for HAP's premiums post tax each month or it may pay for the service(s) via US Tax Code Section 125 (cafeteria plan).

If an employer elects to utilize section 125, the employer may do so in any one of the following manners:
(a) Add the cost on top of the insurance premiums. (e.g. if the employee pays $120/month for insurance, raise it to $125/month to cover the cost of the service. The argument to the Internal Revenue Service is that HAP helps provide administrative services.).
(b) Add HAP's service pre-tax under section 125 (cafeteria plan).
(c) An insurance company may bundle the cost of HAP's services with its own. In this scenario, HAP would receive its premiums from the insurance company on a pre-determined time period (e.g. monthly).
(d) Additionally, the employer may pay for a few basic services and allow the employee to pay for any additional services that he/she may desire.
(e) HAP's services may be paid via an employee's flexible spending account.
   Independent of how the employer would pay for HAP's service(s), the employee's would receive HAP's service(s) in exchange for the premiums paid by the employer.

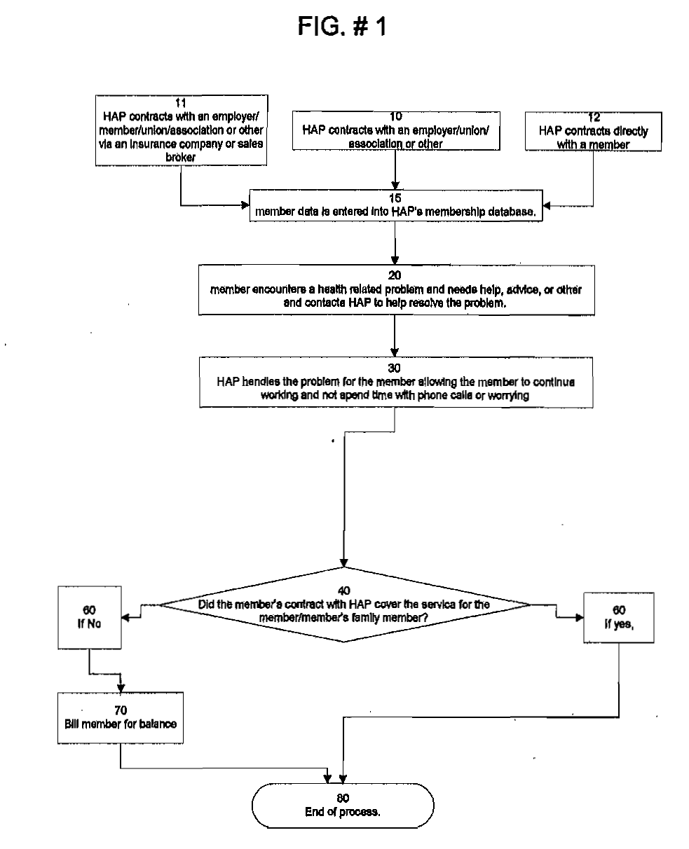

FIG. 1: Process Flow for Employers, Unions, Associations and other

(10) HAP contracts with an employer, union, association or other to provide HAP's services to its employees/members. The employer/union/association/other may either pay for the membership fees for the member, and allow the member to cover any additional costs, or pay for all services the member uses. HAP's services may also cover the member's family if desired.

(11) Contracting with employers, unions, associations as other may also be accomplished via sales brokers and insurance companies. In these situations the broker/insurance company would provide the entity with HAP's contract. (12) The public may also contract directly with HAP. In these cases, the public would contact HAP directly.

Once the contract is signed (15) the member's data is entered into HAP's membership database. (20) If a member encounters a health-related problem and needs help, advice or other, the member will contact HAP. When the member contacts HAP, HAP will verify that the member is eligible to receive the services. If they are not, they will be asked for a payment for the service. If the person calling is an eligible/valid member (30) HAP will handle the situation (s), give advice, research issues or other helping to resolve the issue.

(40) Upon resolution of the issue/problem, HAP will review the member's contract to see if the service provided was covered in full by the contract. If it is not, (70) the member will be billed for the balance. (80) End of process. If the service is covered in full, then (80) end of process.

### Section IV—Unions, Associations and Other

While HAP has obvious benefits to employers and laypersons, it also has benefits to unions and associations. Association like AARP and unions like the Teamsters may use HAP's methodology to benefit their members. When utilized, HAP's methodologies provider peace of mind, problem resolution and the assurance that the association and/or union's member's problems will be addressed and/or resolved in a proper manner thereby protecting the member.

The methodology when contracting with an association or union is: HAP or a person/entity selling HAP's service(s) will contract with the association/union. Personal information for each of the association's/union's members will be entered into HAP's membership database. The association/union would then pay premiums to HAP on a pre-determined time period (e.g. monthly). In exchange for the premiums, the association's/union's members will receive HAP's service(s). If the contract with the association/union was made via a sales broker, the broker would receive its royalty from HAP on a pre-determined time period (e.g. monthly).

### Section V—The Service(s)

HAP's primary goal is to provide essential medically-related services to its members. These services have been tailored to meet the needs of its members.

HAP's experience has shown that these valuable services have streamlined its members' entry into today's complex healthcare system. This streamlined entry allows members to focus on getting better and returning to work. Furthermore, HAP's experience also allows it to answer questions such as, “which treatment plan has the best outcome?”

### Methodology of Each Service

### Health Counselor:

The health counselor is a person or group of people who are dedicated to answering the employees' health related questions. To use the health counselor the employee communicates his/her question with the HAP via e-mail, letter, telephone or facsimile.

Upon receipt of the communication, HAP would verify that the person is eligible to receive services from HAP by verifying the person's information in HAP's membership database. Once membership is verified, the person handling the request will review the communication and determine what question(s) is being asked. If the HAP employee handling the question knows the answer, he/she will reply via e-mail, telephone or letter. If the HAP employee needs additional information, he/she will contact the member and clarify any questions the HAP employee may have.

If the HAP employee then knows the answer to the question, he/she will communicate the answer to the employee. If the HAP employee does not know the answer to the question, the employee will query HAP's knowledge base. If the knowledge base does not contain the answer or the HAP employee determines that additional information is needed, the HAP employee will query other HAP employees and consultants to obtain the proper answer. Once the proper answer is found, the HAP employee will communicate the answer to the member via telephone, e-mail or a letter. If the question was not in HAP's knowledge base, the HAP employee would then enter it into the knowledge base so that others may have access to the knowledge.

An alternative way to implement the service is by having a knowledge base that may be accessed via the Internet whereby members may query the knowledge base for their specific questions. HAP employees would continually add to the knowledge base thereby keeping it up-to-date and complete.

### Finding a Provider:

HAP interviews the member and determines the criterion for the provider (e.g. neurosurgeon, pediatrician, etc), the desired results/outcome, any specific requests (e.g. Christian provider), geographical location of the potential provider(s), financial details including all insurance coverage(s) and whether or not the provider should be in-network. HAP then queries its own database that was developed from prior searches and other databases (e.g. Health Pages, HMO directories, internet searches, drquality.com, hospital referral systems) for the names of providers meeting the pre-set criterion. Though a computerized database is used, someone using the HAP methodology could also search through provider information that is in a written form.

Once a list of providers that meet the requirements (including: geographical, provider sub-specialty, financial considerations including in-network, religious beliefs, etc.) set by the member is developed, HAP begins the credentialing phase. HAP will research the provider's schooling and board certification(s) using the information from Health Pages, a participating MCO, provider referral system or by asking the provider or his/her staff. Once the provider's schooling is obtained, HAP will contact other providers in the area and ask them about the provider's reputation. Once this information has been obtained, HAP will interview the provider and collect data that will be stored in HAP's computerized database or on paper.

If the provider is very busy or uncooperative, HAP may interview the provider's office manager, physician assistant or other staff member who works closely with the provider and has intimate knowledge of the provider. During the provider interview, HAP will ask questions like (a) how many of these [specify member's request] procedures have you done? (b) how many have been positive outcomes? (c) How many malpractice cases have been filed against you? (d) Has your license ever been suspended or revoked in any state? Would you have any reservations accepting a new patient [describe member's medical and financial condition(s)]? HAP will then ask if the provider feels this procedure is appropriate based on the situation and does he/she have any other treatment suggestions.

Once HAP has interviewed all of the providers, HAP will review each provider's credentials, malpractice cases, the number of [these types of procedures] the provider has done, the provider's outcomes, the provider's reputation and more to develop a short list for the member. The member will be presented with the short list and each provider's profile will be explained allowing the member to make an informed decision. All provider information collected will go into HAP's computerized database to allow faster searches in the future.

An alternative way to complete the service is to simply ask the member what type of provider he/she is seeking. Retrieve a list of providers who practice the desired type of medicine from Health Pages, an HMO directory, hospital referral system and/or other and combine them to make a list of providers. Sort through the list of providers to ensure insurance coverage and geographic region meet the member's criterion. That list would then be presented to the member.

Another alternative method would be to: query Dr.Quality.com for outcomes results on the provider. These results would then be sent to the member.

### Finding a Facility:

The methodology for selecting a medical facility including, but not limited to, hospitals, nursing homes, dialysis facilities, radiology facilities, assisted living facilities, rehabilitation and skilled nursing facilities, mental health facilities and more is: Interview the member to understand what kind of facility is being sought; the purpose for going to the facility; all relevant insurance and financial issues; desired outcome; religious considerations; geographical region and more.

Once HAP has obtained the search criteria it beings by developing a list of facilities by the type of facility (e.g. nursing home) and geographic region. This list may be composed from HAP's database; an Internet search of facilities; provider/health associations; a phone book; the state(s) department of health listings; contacting providers in the region; and more. The list may be complied form one, or a combination of the sources listed.

After a list is complied, the member's financial considerations are reviewed for things like, is the facility in-network? Does the facility accept the member's insurance? Are any out-of-pocket expenses within the member's request? HAP then filters out all of the facilities that do not meet the criteria. Once that is completed, HAP then contacts the department of health, in the state where the facility is located, and inquiries as to the state's citation(s) against each of the listed facilities. If the facility is being researched for something that is reported to the state, then HAP will research the state's statistical reports (e.g. if the member is seeking a hospital to give birth, HAP would review the state's statistical reports on how many babies were delivered at that hospital and compare them to other facilities. HAP would also look at the records to see if the facility has a neonatal intensive care unit).

HAP then, in no specific order, contacts providers in the geographic area and inquires as to the facilities' reputation(s). HAP would then contact the Joint Committee on Accreditation of Healthcare Organizations and review their records. HAP then queries a database like Lexus-Nexus or Westlaw to see how many malpractice suites have been filed against the facility. HAP then complies all of the data collected on each facility. The completed list is then sent to the member and the member is instructed to call HAP so that a healthcare professional can interpret what the results mean (e.g. one malpractice lawsuit does not mean that the facility is bad). The complied data is then entered into HAP's provider database for future use.

### Bills & Forms Service:

The methodology for the bills and forms services is: The member will submit their medical claims, forms, billing issues/problems or other to HAP. HAP will either then educate the member on how to resolve the problem or query HAP's knowledge base and send the results via e-mail or letter to the member.

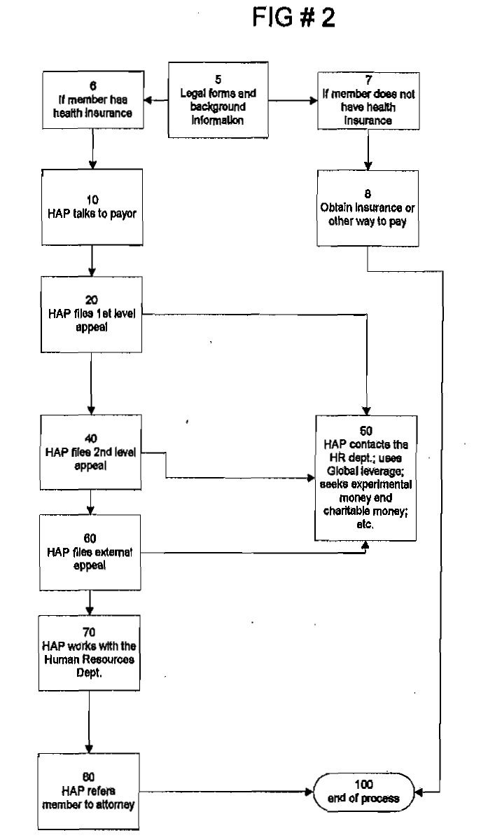

If the member prefers that HAP handle the problem, then HAP will being by creating a new problem tracking record in the member's file (computerized database or paper file). HAP will then identify the member's issue(s) and the entity(s) that need to be contacted to resolve the issues(s). HAP will then contact the entity and inquire as to what is needed to resolve the issue. If records, reports, contracts or information is needed, HAP will obtain the information and forward it to the entity. If forms need to be fill out and submitted, HAP will fill out the form, contacting the member for any needed information, and then submit the completed form(s) to the entity. HAP will then contact the entity in question every four days thereafter to follow up with the issue(s) until the issues(s) is resolved. If other information or problems occur along the way, HAP will use its advocacy methodology, as illustrated in FIG. 2.

### Medical Research:

The methodology for providing medical research is: If HAP is educating the member how to obtain information then HAP would instruct the member to visit internet sites like WebMD, Medscape and Dr.Koop.com. The information on these sites would give the member good information at a level that he/she could understand.

If HAP is compiling the data for the member then HAP would query its knowledge base for current literature on the subject. If a query did not return any results, HAP would then visit Internet sites like WebMD, Medscape and Dr.Koop.com to collect data. On the web sites, HAP would do specific searches based upon the member's specific request (e.g., information on doctors, facilities and outcome results for heart transplants).

HAP would then compile data from publication like JAMA, the Lancet, Physicians Online, Medline and others. The information from these entities is at the level of a medical professional and would need to be summarized for the layperson. HAP's physician would then summarize the data collected from sources like JAMA, the Lancet, Physicians Online, Medline. All of the information and summations would then be sent to the member via e-mail or US postal mail with a note to contact HAP with questions. When providing information to the member, HAP must be careful not to recommend a treatment. Also, HAP's medical personnel could, if desired by the member, translate what all of this information means and work with the member's doctor(s) to educate the member/patient allowing them to make informed decisions about which doctor to use, which hospital, which procedure to use, or whether or not to have a procedure at all.

### Insurance Disputes Service

The methodology for appeal a denial by a payor is: If HAP appeals the denial for the member then HAP must begin by obtaining a consent form from the member. This form allows HAP to act as the member's ombudsman. The consent letter must also include language allowing HAP to obtain the medical records from the provider(s). HAP must then collect all of the medical records from the provider(s). Now HAP will review the member's contract with the payor. When reviewing the contract, HAP will look for any exclusions, capitation or limitations that would apply to the denied treatment/service. HAP will then search published medical literature relating to the denied service. HAP would then file a first level appeal with the payor and, if there is no legal reason for the denial, include that in the appeal. HAP would also summarize and include the bibliographic information for each piece of medical literature that was found relating to the denied service. The member's medical records would also be attached.

If the first level appeal was denied, then HAP would prepare a second level appeal. The second level appeal would address the reason for the denial given in the first level appeal. Again, the legal and medical arguments would be included and the medical records attached.

If the second level appeal is denied, then HAP would request an external review. If an external review is not possible, it would then request arbitration. The external appeal or arbitration would address the reason for the denial given in the second level appeal. Again, the legal and medical arguments would be included and the medical records attached. If the external appeal or arbitration was upheld, HAP would end its efforts.

If HAP was to instruct the member on how to appeal the decision, the methodology would remain the same except that the authorization forms needed by HAP to obtain medical records and ombudsmanship would not be needed.
An example of an appeal letter:
[date]
[payor name & address]
Re: Jane Doe, ID # 555-55-5555
Dear Payor Appeals Department:
Enclosed, please find an EOB for Jane Doe from [insurance company], a prescription form Ms. Doe's doctor and medical abstracts on lymph drainage massage. The charges in this EOB were denied because massage is not a benefit. To that end, I would like to point out that the massage was “Lymph Drainage Massage” and it, and the practitioner, were prescribed by Jane's physician.
While a physical therapist generally administers this type of massage, both [insurance company] and HAP have been unable to locate a physical therapist within 25 miles of Ms. Doe to administer the massage. Because of this, a massage therapist with special training was utilized.
The elements presented in this letter adhere to the member's contract and because of that, I would like to request that [insurance company] pay the member for the services render.
Sincerely,
HAP

### Literature

The methodology for providing literature is: Literature on selecting a health insurance plan, how to handle a hospitalization and more will be given to HAP's members. This literature helps to educate the member. By educating the member HAP is lessening calls to the human resources department. By lessening calls, HAP is allowing the employee and the human resource representative concentrate on their jobs.

### Negotiating a Provider's Bill

Negotiating down a provider's bill is needed when a member's health insurance company denies payment, the member has no insurance, the treatment is outside the health plan's contract and more. In such cases HAP can negotiate down the bill or the member can on their own behalf. The methodology for doing so is such:

Negotiating after the Services are Rendered

The member would sign and return a legal form allowing HAP to act as an ombudsman for the member. HAP would speak with the member and gather information including the provider's contact information, the services provided and more. HAP would then contact the provider and inquire as to the amount owed. When the provider's office gives the amount owed, HAP would inquire if that price was the full amount or the adjusted price that an insurance company would pay.

Background: health insurance companies (payors) have pre-negotiated contracts with providers or usual and customary rate schedule. Generally, a payor will pay approximately one-third the full amount of the bill. Legal precedent in this area has determined that the full value of the bill is not the proper bill as the fair market value for the services is what the insurance companies pay; that amount is one-third the actual billed amount.

If the bill has not been adjusted to the rate that an insurance company would pay, HAP would ask that it be adjusted. If the provider won't adjust the bill HAP would inform the provider's representative that legally, the true market value is what the insurance companies would pay. If the provider's representative is still unwilling to lower the bill, HAP would determine a reasonable price based on Medicare's reimbursement rate for the services rendered in the provider's geographical location.

HAP would then speak with the member and inquire their ability to pay the amount in full. If the member can pay the amount in full, HAP would instruct the member to pay the amount in full and send a certified letter stating, “by cashing this check [provider's name] agrees to accept this payment as payment in full.”

If the member is unable to pay the debt in full HAP would do one of the following:
(a) help the member secure a bank/credit card loan to pay the debt.
(b) refer the client to a medical financing company.
(c) request payment arrangements for the member from the provider (e.g. pay $100 a month until the bill is paid in full).
(d) suggest that the provider write-off the debt base on the Hill-Burton act.
(e) Suggest to the member that he/she have no contact with the provider and to simply send $50 a month to the provider. In these situations, a precedent (legal acceptance) is set by the provider over a period of a few months when the debt goes unchallenged.

If HAP is able to negotiate an arrangement with the provider, then HAP would contact the member and have them agree to the arrangement. End of process. In cases where the member negotiates the bill for him/herself, the methodology would remain the same accept obtain authorization would not be needed.

### Negotiating Before Services are Rendered

The member would sign and return a legal form allowing HAP to act as an ombudsman for the member. HAP would speak with the member and gather information like, what provider is to be used and the provider's contact information; what services are needed; how much can the member afford; the reason the services are needed; etc.

Once HAP has all of the relevant information it will contact the provider and explain the member's medical and financial situation. HAP will then ask if the provider could work within the member's budget or make payment arrangements. If payment arrangements are acceptable to both parties, then HAP's job is done.

If payment arrangements are not acceptable, HAP will solicitant other providers until one is found. Once a provider is found, HAP will try to bundle all of the needed services. By bundling the services HAP can negotiate a better deal for the member.

Example: A HAP client did not have insurance and needed a recommendation if back surgery is needed. The orthopedic doctor wanted $250 to diagnose the patient. But before he could properly diagnose the patient, he needed the patient to have an MRI that normally costs $1,400.

HAP contacts the doctor's office and explained the patient's situation. HAP then contacted an MRI facility and was ultimately able to obtain the doctor's services, the MRI and the radiology report for the patient.

If HAP is unable to locate a provider who is willing to work with the member, HAP may also try:
(a) help the member secure a bank/credit card loan to pay the debt.
(b) refer the client to a medical financing company.
(c) suggest that the provider write-off the debt base on the Hill-Burton act.
(d) Tell the member to seek funds from a charitable source like their parish.
   End of process. In cases where the member negotiates the bill for him/herself, the methodology would remain the same accept obtain authorization would not be needed.

### Section VI—Advocacy

In each appeal, HAP includes the legal, medical, economic, social and ethical, arguments and information, as well as intangible leverage to persuade the payor or provider to grant the member his/her wish.

The method for advocating is determined on the patient's insurance plan and whether or not it is a self-insured plan, Medicaid, Medicare and what is being denied (i.e. treatment, medication, medical equipment, etc).

FIG. 2: Flowchart of HAP's Advocacy Methods

Note: In cases where the member's care is Capitated, HAP would fight not for a treatment, but for an extended stay.

While the approach for every denial will be different, there are some general guidelines that HAP uses when approaching a denial, payment or authorization issue. Also, while HAP can and does use standard denial templates/letters for its denials, each letter that is sent is tailored to the specific issue.

The general method for advocating is: (5) The legal forms allowing HAP to advocate for the member must be filled out and signed. The contact information for the member, payor and provider must be obtained. HAP must speak with the party(s) involved and discuss the problem and the desired result.

Once all of the background information has been obtained, HAP will begin advocating. If the member has health insurance go to # 10. If not, go to # 8.

(8) If the member does not have some form of health insurance then HAP will begin by using the methodology for obtaining care for those without insurance as described in the “specific procedures” section. In short, HAP will try to obtain insurance, negotiate a provider's bill or obtain money from a charity. Additional options are discussed in the specific procedure for “the uninsured and when a payor refuses to cover/pay for treatment:

(10) If the member has some form of health insurance then, HAP will contact the payor and inquire as to the problem. When speaking to them about the problem (e.g. no pre-authorization, needs more information, etc.), HAP will try to resolve the problem at the same time.

If the problem is something simple like needing medical records, then HAP will collect the medical records, or whatever the task may be, and send them into the insurance company to satisfy the payor's request. If this does not rectify the matter, or the issue is more complex, then HAP will file a first level appeal.

At this time HAP will also inquire as to whether or not the member has secondary insurance. If the member does, then HAP will request authorization/payment from them. If this does not resolve the issue, then HAP will continue with its advocacy methodology.

(20) HAP will file a first level appeal. If the member is a provider HAP will use the provider's rights to appeal (e.g. informal dispute resolution as described in Pennsylvania's ACT 68). If the member is not a provider, and most of them will not be, HAP will use the member's rights as a patient.

HAP will prepare the appeal based on the specific procedure laid out for each type of appeal and from the input provided by the discussions with the payor. The specific procedures are found in this section with the heading “specific procedures.”

When filing the appeal, HAP might (FIG. 2, block # 50) contact the patient's employer and/or insurance broker (president or human resources dept.) to pressure the payor. This is particularly helpful if the member is covered under an ERISA plan where the employer can tell the TPA to pay the claim. In addition, HAP may also consider using its global leverage as described in this patent, seek experimental money or charitable monies depending on the situation.

If the first level appeal is upheld, then HAP will file a second level appeal. If, at any point during the appeals process, the provider or other entity is threatening to send the member's file to a collections company or to take legal action, HAP will provide the member with a letter stating that HAP is appealing the issue with the MCO. This action generally suspends any activity by the provider or entity in sending the file to the collection company.

(40) HAP will file a second level appeal. If the member is a provider HAP will use the provider's rights to appeal (e.g. informal dispute resolution as described in Pennsylvania's ACT 68). If the member is not a provider, and most of them will not be, HAP will use the member's rights as a patient.

HAP will prepare the appeal based on the specific procedure laid out for each type of appeal, from the input provided by the discussions with the payor and from the reason for the denial as indicated in the payor's letter stating why the denial was upheld. The specific procedures are found in this section with the heading “specific procedures.”

When filing the appeal, HAP might (FIG. 2, block # 50) contact the patient's employer and/or insurance broker (president or human resources dept.) to pressure the payor. This is particularly helpful if the member is covered under an ERISA plan where the employer can tell the TPA to pay the claim. In addition, HAP may also consider using its global leverage as described in this patent, seek experimental money or charitable monies depending on the situation.

If the second level appeal is upheld, then HAP will file an external appeal if it is available.

(50) At times HAP will contact a patient's employer and/or insurance broker to solicit their help in resolving a problem. Employers and/or insurance brokers can have an impact on insurance companies because there are the client. In cases where the insurance policy is an ERISA plan, the employer can demand that the payor provide authorization or overturn a denial because the plan is a self-insurance plan. In short, the employer owns the plan.

HAP may also use its global leverage as described in this patent. HAP may also seek experimental money or charitable contributions if possible.

Example: HAP has been successful in getting a member's parish to pay for medical treatment.

(60) If available, HAP will file an external appeal with the state's department of health or the payor's external review company.

When filing, HAP will include all pertinent medical records to ensure they are received. HAP will also write the appeal letter based upon the medical or legal issue involved. This appeals letter might address some of the issues raised by the payor in the first and second level appeal, but will also be directed at gaining the approval of an impartial third party based on the facts of the situation/problem.

When filing the appeal, HAP might (FIG. 2, block # 50) contact the patient's employer and/or insurance broker (president or human resources dept.) to pressure the payor. This is particularly helpful if the member is covered under an ERISA plan where the employer can tell the TPA to pay the claim. In addition, HAP may also consider using its global leverage as described in this patent, seek experimental money or charitable monies depending on the situation.

(70) If HAP has not already contacted the employer or exhausted the ability to get the employer involved, then HAP will seek the employer's involvement. Employers can often help as they are the clients. In cases where the insurance plan is a self-insured plan, they can even make exceptions to the plan's policies.

(80) As mentioned in the patent, when HAP files an appeal, it does so in a way that helps if the member decides to file a lawsuit. Whether the suit be for bad faith, liability/negligence, or other, HAP helps to ensure that the lawsuit will be successful.

Example: In one case a member was being denied IV antibiotics. The denial to cover the antibiotics could have resulted in the patient suffering a heart condition. Because of this HAP wrote the payor and placed them on notice that the denial of coverage could result in damage to the heart and its functioning. And now that you [the payor] has been placed on notice, you [the payor] are liable for any damage to the person's heart as a result of the denial.

The payor then overturned the denial.

If HAP is unsuccessful in all of its efforts and sees an opportunity for a lawsuit, HAP will refer the case to an attorney.

(100) End of process.

### Specific Procedure for Enrollment in HAP:

A member may enroll via the Internet. When enrolling this way a web page with information fields and the appropriate legal language, will be made available to members online and an electronic signature will be obtained. All information is stored in a computerized database. If no electronic signature is obtained, a legal form will be mailed to the member for their signature. The purpose of the legal form is to allow HAP to advocate for them. Payment could be mailed in or use of a credit card via a web page.

A member may also enroll at a provider's facility. In this situation the provider will make an enrollment form available to the member the member will then fill out the form and either the provider or the member will mail it to HAP. Payment may also be mailed at that time.

A member may enroll via a pamphlet, direct mail, telephone solicitor or other.

A member may also be enrolled by their employer, a membership with an organization like AARP or a payor as an added benefit, or other company or entity that desires to use HAP's services as a benefit.

Enrollment may also be by way of the medical producer's referral, an incentive plan or by a provider. At time, HAP may work to satisfy the member's request but be paid by the provider, medical producer or sponsor of the incentive plan.

Enrollment may also by via other methods. An example of another method would be via e-mail where all information is sent via an email.

Regardless of how enrollment occurs, the information must be collect and sent to HAP. HAP would then inspect all of the information for completeness and a signature. HAP would then enter the member's information into HAP's computerized database.

If HAP is working with the third party like provider, employer, payor, Medical Producer billing company or other then the third party will receive an e-mail with the list of people covered for will have access to a web page with each member listed.

HAP's e-mail system will integrate with the membership database to track all communications. Currently, TeleMagic, a customer management program is being used to integrate these communication(s), membership tracking, problem tracking, provider and facility information; reporting and more.

### Specific Procedure for Evaluating the Member's Request/Problem:

Ask the member or provider to explain the issue and the desired outcome. Enter this information into the database. This is done by creating a new problem record under the member's primary record.

If the problem involves a payor then contact the payor and inquire as to the reason(s) for the problem (e.g. coverage was denied, bill not paid). The HAP representative would then enter this information into the member's problem tracking record in the database. HAP would then contact a manager at the payor who can make decisions and ask him or her to reconsider the issue. This would be done prior to filing any kind of appeal. Whenever possible, Hap tries to resolve the issue by resolving the payor's complaint prior to filing an appeal.

If the issue cannot be resolved immediately, check to see if there is a secondary payor or personal injury protection (auto insurance). If there is submit the request to them. If they pay for the care, then the process has ended.

Specific Procedure for “The Member Did not Pay his/her Insurance Premiums”:

First, check with the member to see if he/she made the payments. It is possible that they were not posted. If the member made the payments, then contact the payor and advise them of that. The member might have to resubmit payment. If the member did not make payments, then is the member within the grace period for payment (generally 2 weeks)? If he/she is, then send, via overnight mail, payment for all due insurance premiums.

If the member was hospitalized, mentally incompetent, or other, preventing him/her from being able to make a payment(s) then inform the payor of this and include payment in full. When this is done, the member must request, in writing, for the contract to be reinstated.

If all else fails, ask the payor if the member can retroactively pay all past due premiums. This request should be accompanied with a letter requesting reinstatement. If this fails, then have the member go through the payor's appeals system.

### Specific Procedure for “The MCO Rescinded the Member's Contract”:

Was rescinding the contract executed legally? If not, point this out to the payor and request that the contract be reinstated. If not successful, then notify the member that they may want to take legal action against the payor for the legal breech of contract.

If the contract was due to material misrepresentation, then did the payor find out about the mis-representation in a legal manner? If not, point this out to the payor and request that the contract be reinstated. If the payor will not re-instate the contract, then notify the member that they may want to take legal action against the payor for the legal breech.

If the rescission was discovered legally, then was there material mis-representation on the part of an insurance broker? Or did the broker get confused? If either are true, then contact the payor and file an appeal based on the fact that the mis-representation was caused by the broker. If the payor will not re-instate the member, then advise the member that they may initiate legal action against the broker and report him to the department of insurance in the state where the incident occurred.

If a broker instructed the member to make incorrect statement on the payor's application then inform the payor of this and request the policy be reinstated. If the payor does not reinstate the policy, then inform the member that her/she may initiate legal actions against the broker and report him to the department of insurance in the state where the incident occurred.

Check to see if the contract was rescinded within the allowable time period? That is, was the contract rescinded within the statute of limitations or a reasonable time period. It is unreasonable to rescind a contract 2+ years after accepting the member. If the time period was not reasonable, request that the policy be reinstated.

Was the material misrepresentation related to the treatment being covered? If it was not, then it is illegal to rescind a contract because the member required medical services. Also, if the medical services rendered were unrelated to a pre-existing condition, the payor should be notified. The reason is, the treatment had nothing to do with a pre-existing condition and may have caused the material misrepresentation and hence, the rescission. Also has the member been treated for the condition that was mis-represented in the past 2 years? There is a one-year limit on pre-existing conditions. So, if the patent had not been treated for the aliment in the past 2 years, it should not have effected the contract/policy.

If nothing else works, contact the payor and ask them to forgive the mis-representation. If the payor will not forgive the mis-representation and this is an authorization issue, and not a billing issue, then the member should reapply or apply to another payor for coverage. If it is a billing issue, then go through the appeals process.

### Specific Procedure for “The MCO Cancelled/Terminated the Member's Contract”:

If the member's policy has not been cancelled, then inform the payor that cancellation may, by law, only occur if the premiums are not paid or there is a change in the member's employment status (e.g. part-time employee). Then request, in writing, that the policy not be cancelled.

If the policy has been cancelled then were the premiums paid? If they were and the person's eligibility has not changed, then send in copies of the financial transactions (i.e. cancelled check) to the payor showing that the premiums were paid. Follow that up with a letter confirming that the policy will not be canceled.

If the contract being terminated because of an age limitation in the contract then check to see if age discrimination is legal. Also, ask the payor to reconsider the age limit for this member.

If cancellation did occur, check to see if the member given acceptable notice prior to the contract terminating? If not, they must comply with notification laws and hence, must cover the member until compliance is met.

Specific Procedure for “lack of information”:

Did the payor receive all the information from every provider involved? If not, obtain all information from the provider(s) and send all information to the payor. If the problem is still not resolved, were all other diagnoses ruled out? If not, have the provider rule out all other possible diagnoses by examining the patient and performing tests. Then include this information in an appeal.

Other things to check include:

Is member responding to treatment? If yes, include that argument in the appeal.

Is there enough data to suggest the prescribed treatment would be effective? If yes, include that argument in the appeal.

Gather all information then have the physician re-examine the member and look for the specific issues raised by the payor. Have tests completed if necessary. After that, gather all medical records, and argument and go through the appeals system.

### Specific Procedure for “Treatment is Experimental”:

Is the treatment considered experimental in the medical community as opposed to just the payor? If it is, file an appeal and include the fact that the treatment should be covered because medical standards are determined by the community and the community has deemed them non-experimental. When filing an appeal include all medical abstracts that relate to the treatment.

While going through the appeals process, have the member obtain authorization for a treatment that would obtain the same result. If authorization is given, then request that those monies be used for the experimental treatment instead. If the experimental treatment costs more, than the member might have to cover the difference or pre-negotiate the payment.

Also, a lot of payors have money for experimental treatments. This money is used to evaluate the success of new treatments. Does the payor have money for experimental treatments and if so, will they allocate some of that money for this procedure? If not, will the member's church, Hill-Burton Act (or other charitable organization) and provider help with financial contributions and discounts or will philanthropists make a donation to the treatment or bill?

Specific Procedure for “Saving Money when You Will Hit Your Policy Limit”:

Annual limits exist on all plans. Some plans limit mental health to $15,000 a year. Other plans limit dental procedures to $1,000 a year. HAP helps its members in these situations by implementing a simple strategy.

If a member needs to utilize more services than are allowed by his/her payor, then the member should use their entire benefit in that benefit year. Then obtain the rest of the benefit in the next benefit year.

Example: A HAP member wanted her teeth to be capped and her gums to be cut back. The total bill was over $10,000 and her insurance only covered $1,500 for dental needs per year.

HAP instructed her to have her teeth capped in December and her gums cut back in January. Doing it this way she was able to use $3,000 of the insurance company's money whereas if she had done all of it in December, she would have only use $1,500 of the insurance company's money.

### Specific Procedure for “Provider Did not Submit the Claim in a Timely Manner”:

These denials are not the responsibility of the patient/member. What this is, is payors have time requirements for providers to submit claims to the payor (e.g. a provider must submit a claim within 60 days or the provider forfeits its rights to be paid). If the provider fails to submit the claim in time, the provider will lose the money and cannot bill the patient per the payor-provider contract.

The way HAP gets around this is by having the member/patient submit the bill seeking reimbursement for the provider or him/herself. In these situations, HAP or the member would submit a claim form requesting payment be sent to the provider. By having the member, who is not party to the provider-payor contract, submit the bill, the provider can be paid. If the payor refuses payment, then the member can use his/her out-of-network benefits to ensure payment to the provider.

### Specific Procedure for “Pre-Existing Condition”:

Is the pre-existing condition time limit over (e.g. 6 to 12 months)? If it is, file an appeal explaining that the time limitation has expired. Also, does the member qualify for pre-existing condition coverage under HIPPA's 63-day window (note: if you go from one payor to another and there is not a lapse in coverage greater than 63 days, HIPPA applies)? If HIPPA applies, include that in the appeal. Another point to be made in an appeal is that non-ERISA HMOs are not allowed to exclude pre-existing conditions. Include this information in the appeal.

If the member's situation is not covered by the arguments above, then will the payor allow treatment even though it is a pre-existing condition? If not, ask if the member may pay an additional premium in exchange for covering the pre-existing condition.

### Specific Procedure for “Lack of Testing/Medical Evidence”:

Were all other diagnoses ruled out? If not, have the provider rule out all other possible diagnoses and document the chart accordingly. If they were, include that information in the appeal.

Is there enough data to suggest the prescribed treatment would be effective? If yes, include that argument in the appeal. File an appeal and include all the information gathered and include all pertinent medical literature.

Specific Procedure for “Other Diagnoses have not been Ruled Out”:

Is there enough data to suggest the prescribed treatment would be effective? If yes, include that argument in an appeal.

Have the physician re-examine the member/patient and look for the specific issues raised by the payor. Have additional tests completed if necessary and have all other possible diagnoses ruled out.

Gather all of the information and medical literature and file an appeal.

### Specific Procedure for “Payor Deems Treatment not Medically Necessary”:

Speak with the payor an ensure that they have all of the facts. When speaking with them make reference to InterQual, or another nationally accepted set of guidelines, guidelines supporting the member's position. Also mention any “social necessity” issues like (e.g. the patient is elderly and there is nobody to care for him/her).

If unsuccessful, then is the payor willing to try a limited course of treatment to see if the patient/member responds to the treatment? If not, are other payors providing coverage for the treatment? If other payors are covering treatment then include that in the discussion(s) with the payor.

Another thing to try is social necessity. In these cases a person might be able to go home, but without someone there to care for the member, the member's health will deteriorate.

If the payor is still unwilling to provide coverage, then gather all of the medical facts, the social necessity facts, medical literature and go through the appeals process.

### Specific Procedure for “Treatment to Date has not Shown Improvement”:

Have treatment goals been met? If they have include this in discussion/appeals with the payor. If they have not, has treatment been given a reasonable period of time to take effect? If the treatment has not had enough time to take effect, include this in discussions/appeals with the payor.

Would changing dosage or amount of treatment make a positive effect? If so, include this in discussion/appeals with the payor. Also if there an alternative treatment protocol and the member is willing to undergo this treatment, request authorization for that (if the issues is authorization).

If the payor has not allowed/paid for treatment, and use of an alternative treatment is not possible, gather all of the information and go through the appeals process.

### Specific Procedure for “Provider is Out-of-Network”:

Is the provider willing to accept the payor's reimbursement rate? If so, ask the MCO to reimburse the provider at their usual and customary rates. If that did not work, then check to see if there is a provider within 25 minutes of the member's house. This is being done because if there is not a provider within 25 minutes of the member's house, the MCO must make alternative plans to provide the needed service/care to the member.

Example: A HAP client needed lymph drainage massage. Because a physical therapist trained in lymph drainage massage could not be found, HAP was successful in getting the MCO to pay for a trained massage therapist.

If not successful, will the provider enroll as a participating provider for the payor? If so, will the payor allow the doctor to enroll? If both agree, then the provider will become in-network and the member may then be treated.

If still unsuccessful, then has the patient/member already started treatment with the doctor? If so, it would be unethical and improper to force a member to discontinue treatment until the treatment is complete (e.g. finished treating the cancer). Explain this to the MCO and if needed, include in an appeal.

Another argument that can be used is if the provider has special qualifications (i.e. he invented the procedure?) In such situations, MCOs sometimes allow the provider because 1) they can save money by having the member treated by the foremost provider. 2) one could make the argument that there is not a proper provider within 25 minutes of the MCO. In this case a proper provider would be considered someone who has treated this type of case before.

If all has failed, gather this information and go through the appeals process.

Specific Procedure for “The Provider is not a Doctor, PT, or Properly Licensed for the treatment”:

In such situations it is legal for an assistant to perform treatment under the direction of a licensed provider. Have the patient arrange to have the treatment done by the non-licensed or improperly licensed (e.g. physical therapist) provider under the direction of a licensed provider.

If this does not resolve the problem then, does the desired treating party have any special qualifications (i.e. he invented the procedure?)? If so, then use this in discussions/appeals with the payor.

If this was not successful then gather all the information and go through the appeal process.

Specific Procedure for “The Provider Had his/her Assistant Perform the Treatment”:

Was the assistant under the direct supervision of a doctor or licensed therapist? If so, then litigation to date allows a technician to treat a patient under the direct supervision of a licensed provider.

If this was not successful then gather all the information and go through the appeal process.

### Specific Procedure for “A Care Level is Denied”:

Begin by asking the payor why care level is being changed/denied. Be sure to ask the specific reason why the change is being made.

Care levels are generally changed due to medical necessity reasons. Go to the “Specific Procedure” for medical necessity and follow those instructions.

### Specific Procedure for “Part or None of Bill is Paid”:

If the problem is listed below, then go to the specific procedure for it:
a. Was treatment medically necessary?
b. Was the provider in-network?
c. Was pre-authorization obtained?

### Also:

d. Did the member pay their copay? If not, have patient/member pay copay.
e. Check to see if the deductible was met. If it was not, have the member pay it.
f. If the problem is that the provider did not submit the bill to the payor in a timely manner (as described in their payor contract), the member is not responsible for the payment.
   If all fails, gather all of their information and go through the appeals process.

### Specific Procedure for “There is a Difference Between the Provider's Charge and the Payor's Usual and Customary Rate”:

If the member is in-network this cannot happen. If the member is out-of-network then, does the member have Medigap insurance that covers “part B excess?” If not, then the member can pre-negotiate the provider's bill prior to being seen by the provider or find another provider. If the member learned of the bill afterward, then:
a. the member can still negotiate the bill.
b. If the member is on Medicare or Medicaid case and state laws apply, then the provider cannot charge more than Medicare's/Medicaid's usual and customary rate.
   Specific Procedure for “Treatment was Provided Outside the Payor's Area (e.g. Different State)”:

Was the treatment an emergency? If so, most states have legislation; and plans regulations, that emergency room visits are covered anywhere in the United States.

If the treatment was not an emergency, does the policy have out-of-network benefits? If so, utilize the out-of-network benefits.

If still unsuccessful, was the member treated by an in-network provider that is contracted outside of the member's contract area?

Example: ABC Insurance company is nationwide. The member lives in Colorado but was treated by an in-network provider in Florida.

If this is the case, ask if the member can simply pay the difference in reimbursement between what is would have cost if care was provided in their contract area.

If still unsuccessful, then gather all the information and go through the appeals process.

Specific Procedure for “Desire Request is Outside Contract Parameters (e.g. Massages, Specific Provider)”:

See specific procedure for “obtaining additional benefits outside the policies limits.” If that does not work, is there an alternative that is acceptable to the payor, member and provider? If so, use the alternative.

Do other payors cover the requested treatment? If so, point this out to the payor. Also, is there literature to support the request? If so, include this in any discussions/appeals with the payor.

Gather all the information and go through the appeals process.

### Specific Procedure for “Disagreement Over Who is the Primary Payor”:

If the member is a dependent, then the primary payor is determined by the policyholder's birth date. The policy whose holder (guardian) has the earlier birth date is the dependent's primary payor.

For non-dependents, the primary payor is determined by the policy that has been in place longer. Contact both payors with each policy's information and the policyholder's information.

If the issue has not been resolved, then gather all of the information and file an appeal with both payors and allow them to resolve the issue.

Specific Procedure for “Medical equipment is not ready/available”:

This denial only effects payment to providers.

Was equipment being used for other patient(s) covered by the payor? If so, gather this information. Notify the payor that the equipment was being used for other patients/members of the payor. If not successful, gather all of the information and go through the appeals process.

### Specific Procedure for “Benefits/Cost/Treatment Ran Over Authorized Limits”:

Was there authorization for additional treatment(s)? If so, notify the payor of the additional authorization and include documentation of the additional authorization in a letter to the payor. If this was not successful, then were the minimum treatment requirements for the protocol met? When arguing this include that fact, if true, that the patient showing improvement?

If the care has not already been given, then have the treating provider write a new prescription for the treatment. Also, some health insurance plans have a “reload” feature, where, for a fee, insurance benefits will be extended/reloaded.

If all has failed, then gather all of the information and go through the payor's appeals process.

### Specific Procedure for “Non-Formulary Treatment/Treatment not Supported by Payor”:

Is there another treatment protocol that is acceptable to the patient/provider and payor?

If so and the alternative is acceptable tot he provider and member, then use the alternative protocol.

If not, are other payor's covering this treatment? In an earlier section HAP discussed the theory of the MCO's standard of care. When making this argument, include literature to support why this treatment is medically necessary.

If still unsuccessful, then have the member become approved for an alternative treatment. Once approved, argue that the other treatment is better and to allow the member to apply the cost of the approved treatment to the un-approved treatment and that the member will pay and difference.

Also, seek to see if another provider is obtaining coverage for the treatment form the same payor. As HAP has discussed, provider-payor contracts differ. If that does not work, and there is a payor that is covering the treatment, have the member switch payors.

One other tool is experimental monies. All insurance companies have money for experimental treatments/clinical trials. Offer to share the member's outcome data with the insurer in exchange for experimental monies.

If all else fails, gather all of the information and go through the payor's appeals process.

### Specific Procedure for “Obtaining Additional Benefits Outside the Policies Limits”:

First, negotiate. Demonstrate how a small investment now will save them money in the long run.

Example: By allowing additional outpatient mental health visits, the patient can be controlled thereby avoiding an almost certain admission to an acute care hospital and/or mental hospital.

Most payors allow two out-patient mental health visits for every one in-patient mental health day.

Other things that can be done are conversion. In these situations an MCO will give a patient two (2) out-patient visits for every one (1) in-patient day allowed by the policy. Also, some health insurance plans have a “reload” feature, where, for a fee, insurance benefits will be extended/reloaded.

If negotiations still have not worked, then HAP can threaten litigation based on bad faith or will appeal the decision through binding arbitration if the policy allows binding arbitration. If arbitration is not a possibility, then gather all information and go through the appeals process.

Note: all payors have built in extra monies for their members to use. The point is to find a way to allow them to allocate that money to the specific member. In other situations, payors will allow members to convert (conversion) benefits. The example above is good example of haw to convert benefits.

### Specific Procedure for “Member was not Transferred by an Ambulance”:

Was the transfer between two providers ? If it was not there is no legal reason that the member/patient had to be transferred by ambulance. Notify the payor of this and allow them to resolve the problem. If that was not successful, then would waiting for an ambulance put the patient's/member's life in danger? If so, include that in discussions/appeal with the MCO.

If still not successful, then gather all the information and go through the appeals process.

### Specific Procedure for “Pre-Authorization was not Obtained”:

If the treatment was an emergency or he patient was incoherent then explain the situation tot he payor. If not successful, did the treatment need authorization? If not explain this to the payor. If it did need pre-authorization was pre-authorization obtained but by provider? Often pre-authorization is given but lost in the payor's computer system. If the provider did obtain authorization then send a copy to the payor.

If still not successful, then are there out-of-network benefits available? If there are, then use the member's out-of-network benefits. Finally if that does not work, payors will sometimes allow the charge to ensure member satisfaction. Ask for the payor's forgiveness in not obtaining pre-authorization.

If everything fails, gather all of the information and go through the payor's appeals process.

### Specific Procedure for “Payor Denied Payment for Emergency Room Visit”:

Was the ER visit deemed reasonable by a person of average intelligence? If it was, most states have laws, and insurance plans regulations that deem is a person of reasonable intelligence thinks the situation is an emergency then the payor must cover treatment.

In these situations HAP would go through the appeals process with/for the member. When going throughout he appeals process, HAP would show how the member, who is of reasonable intelligence, thought the situation was a true emergency.

### Specific Procedure for “The Member has Already Exhausted the Appeals Process.”

If the issue is an authorization issues, then have the member go back tot he doctor for a new prescription. This will start a new appeals process.

If the provider has already appealed the decision, then claim that the provider used the informal/alternative disputes resolution process and that HAP is now using the member's rights.

If the situation is not an authorization issue and the member's appeal rights have been exhausted, then request that the appeal be re-opened/re-heard. HAP has been successful in doing this.

### Specific Procedure for “Obtaining an Extended Length of Stay”:

If the member simply needs one or two extra days, HAP can file an appeal for the member. Most state laws and MOC polices state that the payor must pay for every day that the payor's member stays in the facility while the member's care/stay is under appeal. This methodology is a simple way to obtain one or two extra days stay for the member.

This methodology may also be used by providers when the MCO informs the provider that the member's coverage has ended and the provider is unable to place the member in another facility or home. The purpose for this is if it takes a day to place the member in skilled nursing facility, the provider generally has to absorb that cost. Using this methodology, the provider has a mechanism by which it can obtain payment from the MCO for that day (or two).

### Specific Procedure for “Medicare and Medicaid Member's to Overcome Authorization Issues”:

If a member is eligible for Medicare or Medicaid and they are currently in a Medicare-HMO plan, or a Medicaid-HMO plan, then they can possibly overcome the authorization issue by returning to straight Medicare or Medicaid. The member might have to wait to do this (e.g. January 1^{st} through June 30th), but it can be done.

Specific Procedure for “The Uninsured and when a Payor Refuses to Cover/Pay for Treatment:

Depending on the member's financial situation do one of the following:
a. Negotiate the provider's bill. This methodology has been described.
b. Ask the provider if they have any Hill-Burton funds available to cover the costs.
c. Inquire with the member's parish, or any parish of they would pay for the member's care.
d. Inquire with charitable organizations to see if they would cover the cost of care.
e. Help the member apply for Medicaid, disability or other.
f. See if the care can be covered by a worker's comp. policy, PIP claim, personal injury claims or other manner in which the provider can attach a lien.
g. Pharmaceutical companies have grants for people with low-income. If the member needs medication, have them apply for a grant.
h. Medical financing companies exist that will finance care. Have the member apply for financing.
i. Have the member apply for a bank loan or credit card to pay for the care.
j. Contact private philanthropists, trusts and organizations to donate money.
k. Check to see if there are any clinical trials or research projects.
   Specific Procedure for “Other Situations that have not been Specifically Identified”:

First, identify the problem and try to resolve the problem with the payor using whatever means best suited to solve the problem. If the problem was not resolved seek other options. Again, if the situations was not resolved, gather all of the information possible and go through the appeals process.

### Specific Procedure(s) for Going Through the Appeals Process:

HAP begins all interactions with payors via verbal discussions. IF not successful then it begins the appeals process. In every appeal, whether is be the first level, second level, external review or arbitration, HAP implements the following in its communications/appeals with the payor:
a) Research the medical guidelines (e.g. InterQual) and if they support to request, cite them in the appeal.
b) Obtain all available medical literature on the subject and include it with the appeal.
It is part of HAP's methodology to educate the MCO reviewer(s) in the event they have not had adequate exposure to the topic.
c) Research other payors and providers in the area to see if another payor is covering the treatment of if another provider, contracted with the same payor, is obtaining coverage for the treatment.
d) HAP's global leverage is ever present and HAP will always try to ensure that the payor is aware of HAP's global leverage.
e) Whenever possible HAP will incorporate ethical arguments into its appeal. Example: the patient only has six months to live so why not allow the experimental procedure.
f) Whenever possible HAP will incorporate legal issues, the payors policies and regulations, and any contractual agreements the provider may have (e.g. in a Medicaid contract a payor might promise to allow specific drugs to be used). Example of a legal issue: there is no provider within 25 minutes of the facility therefore, the payor must make alternative remedies.
g) Whenever possible HAP will setup the payor for a lawsuit (e.g. Bad faith, personal injury, etc.). This is accomplished by including proper legal language in the appeal letters thereby placing them on notice or showing a pattern of neglect.
h) Whenever possible including economic issues showing how approving/covering treatment will save them/their client, if it is a self-insured plan, money.
i) HAP gather's all of the medical records that support the member's request.
j) Whenever possible, HAP will request that the employer become involved to help pressure the payor to allow the request.
k) HAP always obtains at least one letter of medical necessity prior to beginning an appeal.
l) HAP may contact a supervisor at the payor to put pressure on the reviewer to approve authorization/coverage.
m) Whenever possible, HAP will appeal the decision in person and make a presentation.

### First Level Appeal:

HAP begins by collecting data. The data includes the reason the MCO gave the provider, member and/or other for the denial. It also includes information about the denial that HAP received from its discussions with the payor and the provider.

HAP then consults with the legal, medical, ethical, billing and insurance people on its staff for input into the situation; not all input is required as the staff is cross trained. After all of the input is gathered, HAP files the first level appeal and includes all of the aspects listed above (letters A through L). Again, if it is possible HAP will appeal the denial in person.

When writing or presenting the appeal, HAP will concentrate on overcoming the reason the payor gave for the denial.

### Second Level Appeal:

If a second level appeal is needed, HAP will begin by obtaining the denial information from the provider, the member, the first level denial and any other information it can obtain.

HAP will then consult with its staff and conduct research to overcome the payor's reason for the denial. Upon completion of that, HAP will incorporate all of the elements listed above in letters A through L.

HAP will then either write an appeal letter or present the information in person. When writing or presenting the appeal, HAP will concentrate on overcoming the reason the payor gave for the denial.

If the denial is not overturned at this time, HAP will log the problem with the payor in its database. The purpose of this is to provide the NCQA, the state's departments of health and insurance, employers and other entities with information on the payor's questionable practices.

### External Review/Binding Arbitration:

If available, HAP will file an external appeal or submit to binding arbitration. An external appeal is when an independent party reviews the need for treatment.

HAP will begin by obtaining the denial information from the provider, the member, the first level denial and any other information it can obtain. HAP will then consult with its staff and conduct research to overcome the payor's reason for the denial. Upon completion of that, HAP will incorporate all of the elements listed above in letters A through L.

HAP will then either write an appeal letter or present the information in person. When writing or presenting the appeal, HAP will concentrate on overcoming the reason the payor gave for the denial. HAP will also obtain copies of all the medical records that pertain to the member's request, highlight the significant issues, and send them along with the review. While the payor is generally required to present all of the medical records, HAP has no way of knowing if all of the records were sent. Also, HAP wants the ability to highlight specific passages.

If HAP's efforts have failed at this stage, HAP might try to begin the process again by obtaining a new prescription or trying to re-open the case.

### Section VII—Contractual Relationships

When a patient is treated by a provider they are unknowingly allowing themselves to be limited by the provider's contract with the payor. In short, there are two contracts in place. The patient's contract with the payor and the provider's contract with the payor. What happens is that people implicitly make the assumption that the patient is bound to the limits of the provider's contract. This is not true. Furthermore, provider contracts differ from provider to provider.

HAP's methodology overcomes the boundaries of the providers contract for the patient because the patient did not agree to allow himself/herself to be bound by the provider's contract. Instead, HAP makes arguments including, (1) if another provider down the street has it in their contract, then the patient should be allowed to have it. (2)

The obligation of the payor is to provide medically necessary treatment to the patient/member. To that end, if it is medically necessary, the payor must provide coverage for it regardless of the provider's contract.

Example: A patient has a history of post surgical nausea. Because of this the anesthesiologist would like to prescribe Tagamet IV but cannot because the physician, physician group and/or hospital entered into a contract that did not have Tagamet IV on its formulary. In this situation, the patient will be covered for the Tagamet IV.

In another hospital, approximately five minutes away, a patient covered by the same payor, is receiving Tagamet IV because the physician, physician group and/or hospital fought to have Tagamet IV placed on their formulary.

Based on the two situations above, one can see how a patient is bound/limited by the provider's contract with the payor. And having no knowledge of the contracts that other providers have negotiated, will accept the care provided to them.

### Section VIII—Global/Intangible Leverage Process Flow

There are many ways to go about obtaining payment from payors and overturning MCO denials. For example: providers generally submit claims for payment and if payment is not received, call to follow up with payment. They may even submit the bill to a lawyer who would sue the payor and/or the patient.

Collection agencies submit claims, make phone calls and send letters to the payor and/or the patient to follow up with claims. If they are unsuccessful, they often send the claim to a lawyer.

With regards to MCO denials, providers generally use a patient's medical facts to fight MCO denials. If the MCO upholds the denial, there is little the provider can do.

To ensure payment from the payor and that denials are overturned by MCO's, HAP uses global leverage in addition to the specific actions it takes. The global leverage includes:
a) A web page listing the denials and questionable actions on the part of payors. The point of this is to alert the public, employers and the media of all the questionable actions and inappropriate denials of each of the insurers, The employers and public can then question if they want to continue with the named insurer.

### Example:

The following is an alert on what insurers are denying.
Note: the following are the views of HAP only.
The following is for informational purposes only.
June/2001—ABC Health Plans has been denying authorization for Lyme Disease.
August/2001—XYZ Health Plan has not paid claims that had pre-authorization.
November/2001—Community Health Plan rescinded a member's contract because she made a mis-representation on her application. The fact of the matter is that she was confused by the way the insurance broker asked the question. Now that there is a $10,000 hospital bill, Community Health Plan has rescinded the contract based on material mis-representation.
b) Campaigns including letter campaigns, e-mail campaigns, phone call campaigns, public gatherings and other types of campaigns where HAP will ask its members to contact the insurer, employer, union and/or government representative and have them put pressure on the insurer to reconsider the specific issue raised by HAP.
c) Launching public relations campaigns telling the media about the action(s) of an insurer. HAP will contact representatives of TV shows, magazines and newspapers and try to have a specific story told about what an insurer is doing to a member(s). Such publicity is meant to cause the insurer to resolve the issue(s) in a manner that is acceptable to HAP.
d) Telling its members and employers not to use a specific insurer and to instead, use another payor that HAP deems a responsible payor.
e) When advocating for a member HAP will setup the insurer for a lawsuit. Whether the lawsuit is for bad faith, substandard quality of care, RICO act, personal injury, compliance issue or other. This is accomplished by writing to the insurer and placing them on notice. By notifying the insurer that not covering a specific treatment will result in a detrimental or adverse reaction to the patient. For a bad faith lawsuit, HAP will try to structure things so that a jury could see how the insurer was negligent in its actions. For compliance lawsuits, HAP will structure its interactions and communications to show how the insurer did not comply with federal, state and local laws and regulation(s). Example, an insurer denied coverage for Lyme disease because the patient's serological tests were equivocal. The issues here was that the State of New York stated that Lyme is a clinical diagnosis and that serological testing could not be used to deny care. In RICO cases, HAP will show a pattern of denials to multiple patients/members.
f) Requesting local, state and federal department(s) of revenue to issue a tax penalty on an insurer that operates under a non-profit status. The point of this is to impose financial penalties on the insurer showing the insurer that HAP has the ability to affect their bottom line and to enlist the help of other agencies.
g) Filing grievances both internally, with the insurer, and externally with the state's Departments of Health and Insurance. The point of this is to increase the percentage of grievances and complaints with the state's Department of Health and Insurance thereby causing local, state and federal agencies to investigate the insurer.
h) Filing amicus briefs supporting HAP's member when litigation is involved with an insurer. The point of this is to add support in litigation against insurers. This action will give HAP more leverage when advocating earlier on in the advocacy process.
i) Investigating if other insurers in the area are providing coverage or reimbursement for the same procedure(s) begin denied by the payor in question. The point of this is that the “standard of care” is determined by the care being rendered in the community. Therefore, if other payors are covering the care, then it becomes the standard of care.
j) Investigating all local, state and federal laws and regulations to ensure the payor is in compliance.
k) Making an annual report to employers, the state departments of health and insurance, and NCQA on all questionable denials.
l) Using the patient's rights, not the providers. Patient complaints are given more consideration by payors because the laws, and the departments of health and insurance stress patient rights, not provider rights. Also, the patient is the customer (this goes to customer satisfaction).

### Section IX—Authorization and Payment Plan

a. Summary of The Authorization and Payment Plan

HAP's Authorization and Payment Plan (A&P Plan) was designed to ensure authorization and payment from payors.

With the added levels of complexity in today's healthcare system, patients and providers alike are finding themselves increasingly frustrated when trying to obtain authorization and payment. To that end, HAP has developed an effective approach to obtaining authorization and payment. Best of all, the implementation of The A&P Plan does not cause any additional work for the provider (no additional paperwork, no additional phone calls, etc). It is a single source solution whereby cases may be sent to HAP, on a case-by-case basis, and all work, including gathering information, and obtaining authorization and/or payment, will be the responsibility of HAP.

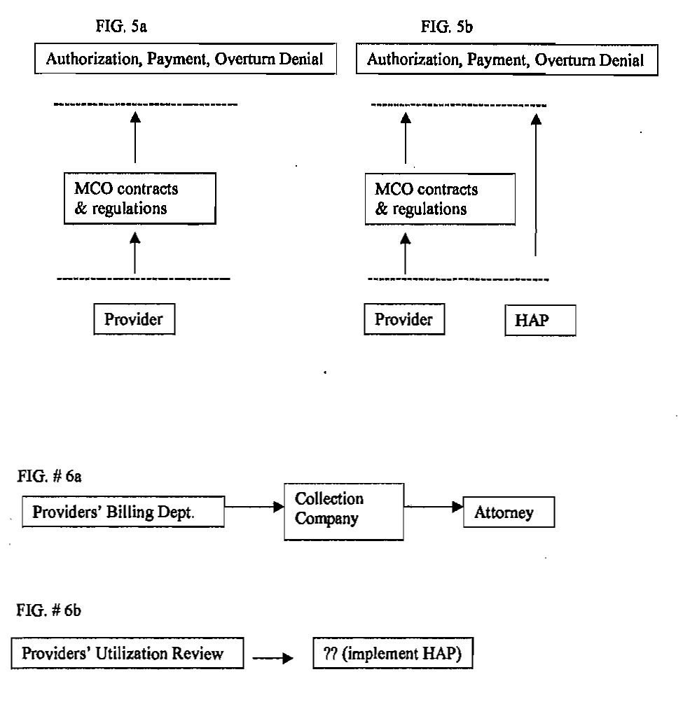

FIG. 6a and FIG. 6b contrasts how billing departments have three levels/stages of collecting outstanding monies and how providers only had one level for authorization and payment until HAP was developed.

b. Benefits of The Authorization and Payment (A&P) Plan
1. Authorization for treatment, additional visits, non-formulary medications, etc.
Obtaining authorization is always a time-consuming battle and often requests are denied. In such instances, HAP will help to obtain authorization and coverage. In short, once A provider notifies HAP of a situation, HAP will begin its efforts to obtain authorization and coverage.
An advantage of using HAP to advocate for treatment is perception. In discussions with hospital management and providers HAP has found that when a provider advocates for treatment, they are often perceived as “trying to line their pockets.” To that end, A provider will be insulated from such perception by using HAP to advocate.
2. Non-payment by payors
Every year physician offices/hospitals write-off, or send to collections, thousands of dollars because the insurance companies did not pay. With this plan, HAP will facilitate the recovery of monies due from the insurance companies at a lower cost than charged by collection agencies and attorneys.
3. Increased cash flow
Due to an increase in authorized treatments and collections within 120 days, cash flow to the hospital will be increased. Legal note: increased cash flow is not The A&P Plan's objective, it is merely a residual benefit.
4. HAP helps the patient through the cross-continuum of care
The A&P Plan is designed to help patients through the continuum of care from a financial perspective. A patient should never be denied a medically necessary procedure, medication, rehabilitation facility or other because it is not on an insurance company's formulary or in their financial interest.
5. Protects physicians from being accused of fraud
Physicians have been known to “color” patient diagnoses to obtain insurance company authorization, the doctor doing so to ensure proper care. The problem is that in doing this, the physician has committed fraud. HAP hopes to ease the physician's burdens by partnering with the doctor and approaching the insurance company to request proper care.
6. Safeguards patient's medical history
The “coloring” of patient diagnoses could also haunt the patient in the future in the form of medical insurance discrimination. For instance, instead of being diagnosed with heartburn, the physician may make a more dramatic diagnoses such as severe gastroesophageal reflux disease. This may ultimately come back to haunt the patient with increased insurance premiums, preexisting conditions clauses or denied life insurance simply because the patient now has a black mark in their medical history.
7. The right to appeal a decision
Traditionally providers have always been the patient's advocate. This remains true today. Though the doctor continues to be a patient advocate by presenting medical facts to the insurance company, he/she cannot do anything once a denial has been rendered. While Act 68 (PA) and Milliam & Robertson guidelines give providers some abilities to advocate, their abilities are limited. This is why HAP is so useful to providers. HAP can advocate for the patient when the provider cannot and have denials reversed.
   b. Process Flow & Implementation
1. Authorization and payment
   When advocating for authorization or payment HAP can be an authorized agent of a provider and/or the patient. It has been HAP's experience that utilizing the patients' rights produces a better result. It is precisely this reason that many hospitals place the patient between them (the hospital) and the payor. Another reason HAP prefers to use the patients' rights is that if a provider advocates for treatment, they are often perceived as “trying to line their pockets.” Because of these reasons, HAP would like to use the patients' rights, if possible. There are two ways to accomplish this:
I. When patients register at providers facility they can be
   given an authorization form to sign (or enroll via a web page), along with all the other forms, allowing HAP to advocate on their behalf if a problem develops. This information will include basic contact information, insurance carrier, provider name and a contact person in the event the member is not available (this information will then be entered into HAP's database). This seamless approach is the best implementation as it would allow HAP to obtain authorization and payment for the provider at any time. In addition, the need to interrupt the patient during their stay (for a signature) or notify them later of a problem has been avoided. It has been HAP experience that such an approach leads to increased patient satisfaction.
II. An alternative method is: When a situation with a payor develops, a the provider's representative can simply say to the patient, “we need your authorization to work with your payor. Would you please sign this?” That form will then be faxed to HAP allowing HAP to advocate for the patient. Because payment issues arise after the patient has been discharged, HAP will contact the patient to request a signature (for payment issues only).
2. Notifying HAP of a problem
I. Authorization issues
   When an authorization problem has been identified, a provider may inform HAP of the problem via e-mail, telephone, facsimile or by mail. While any of these means would work, the simplest way would be to simply fax the Patient Information Form, with a brief description of the issue, to HAP. Once notified, HAP will go to work to resolve the issue(s).
II. Payment Issues
   Depending on the number of claims a provider would be sending at one time, it may either fax or mail copies of the bills to HAP. If a large number of bills are to be sent, or if it is easier for a provider, a comma-delimited file (computer file) containing the relevant information may be sent to HAP via an encrypted e-mail or computer disk sent via the US. Mail.
3. Procedure for obtaining authorization
   When HAP is contacted by a provider, HAP will do all of the work including locating and discussing medical issues with the physician(s), speaking with the patient, working with the insurance company, etc. In short, once the pertinent information is received, it will be HAP's responsibility to handle all aspects of gathering information and obtaining authorization.
   Note: It has been HAP's experience that not all authorizations are given immediately. It is possible that the patient will have been released by the time authorization is approved. Because of this, a provider must make the determination to provide care, even though authorization has not yet been granted, in the hopes that it will be. These determinations will have to be made on a case-by-case basis. (HAP has been informed that a provider does provide any care deemed necessary even if the care is not approved by the insurance company. The statement above simply addresses the timing issue that sometimes arises and is not an indication of adverse financial considerations or other).
4. Procedure for handling payment issues
   The old saying is, “an ounce of prevention is worth a pound of cure.” To that end, HAP will solicit reimbursement from the insurance companies for any claim that A provider deems necessary (necessary being defined by number of days overdue and dollar amount). By having HAP advocate for payment, a provider will reduce the number of claims sent to collection agencies and lawyers thus saving a provider money (savings are based on the collection agencies' and attorneys' rates).
   Another bonus of HAP's involvement is that if HAP is unsuccessful, a provider may still pursue its legal remedies through other channels (i.e. collections agencies and lawyers).
5. Alternative Billing
   Another way that HAP can integrate with a provider is by having the provider pay for HAP's services. In these cases, the provider would pay HAP to advocate for the patient. The point of this is to use HAP's methodology when advocating for authorization, payment, benefits, etc.
   When HAP is integrated with a provider, there are some legal issues that need to be addressed. These issues include HIPPA Privacy Regulations, Medicare accountability and holding the patient harmless in the event that HAP causes a trigger making the patient liable for the bill. To address each of these issues, a provider contract should include language for Medicare's access to books and records regulation, language to hold the patient harmless; and HIPPA compliance.

### Section X—Timeline of Care

While non-medical personnel are generally not knowledgeable of this, a goal of providers is the seamless continuum of care. In short, providers are interested in patients going from one form of care to the next with as little disruption as possible. An example is a person who is treated in an acute care hospital, then transferred to a skilled nursing facility, then being followed up with a home healthcare company. While the medical profession has spent a lot of time ensuring a positive experience and a seamless continuum care from a medical prospective, they failed to address the “financial continuum of care.”

Patients will often be denied to a rehabilitation hospital, a proper stay at a facility and other due to MCO denials. HAP helps to ensure a proper and seamless “medical continuum of care” by ensuring the “financial continuum of care.”

In the past, there have always been multiple entities involved in ensuring payment/coverage for care. These entities enter into the equation at different times.

For example: if a patient was denied coverage for treatment by an MCO, the patient's doctor or an advocate would advocate for coverage. Once in a provider's care, the providers staff would advocate for payment and handle denials from the payor and/or patient. Then, if payment was not received, the provider could send the bill to a collection company; if the collection company was not successful, the collection company or provider could then initiate a legal action, generally with the assistance of a lawyer.

While the current model works, it has its limitations. Those limitation come from scenarios like, what if the acute care hospital does not want to invest the resources to advocate with an MCO if a denial is incurred. After all, if the patient is going to another facility anyway, then what is the hospital's incentive to advocate? Yet another difference is the ability to be successful. In a Dallas Morning News Report, it states that providers are successful in overturning denials 43% of the time. A report release by the Pennsylvania department of managed care states that the layperson can be successful 83.5% of the time if they use all appeals available to them. To that end, HAP is much more successful at overturning denials that providers.

An example of this is:
Paul had been in a rehabilitation facility recovering from a stroke when he had a relapse. Paul was then rushed to a nearby emergency room where he was treated and later admitted to the hospital to stabilize his condition. Five days later Paul's physician and family wanted him to return the rehabilitation facility. The payor would only approve a skilled nursing facility. HAP became involved and eventually the payor authorized the rehabilitation hospital.
The point here is that without a “financial continuum of care,” the medical continuum of care is irrelevant for it will not exist.

HAP overcomes the problem of the fragmented financial systems currently found in the medical industry by showing a person, or having a single, third-party entity resolve or help the treating entity resolve any problem that arises. In this scenario, Hap would advocate for treatment, advocate if a denial was given by an MCO, file a claim if the patient's bill was not paid and help resolve a financial issue if the patient does not have insurance or there is a problem in getting the payor to pay.

HAP's involvement may be used by providers or the patient. If it is implemented by a provider, the provider would simply appoint HAP as an advocate for the patient or pay for HAP's fee and have the patient appoint HAP as their advocate; all appropriate legal forms would need to be signed. Again, the advantages are a non-fragmented financial system; there is no rationing of resources based on the fact that advocating for the patient only benefits another entity; HAP's goal is to ensure the patient's and providers' bills are paid; HAP success record at overturning denials and obtaining payment from providers is greater than providers; and more.

If HAP's system is being used by a layperson, they need do nothing more than to follow HAP's advocacy methods when a denial is obtained.

FIG. 3: Authorization and Payment Plan and Provider Integration Process Flow

There are several ways to approach a denial. They include:
a. If there is only one appeal process available
   1. HAP can begin its advocacy campaign once the provider has decided that it no longer wants to, or decides it is best, that HAP continue with the denial.
   2. HAP can present its case in concert with (sharing data and thoughts), or independently of the providers case under the umbrella of the same denial.
b. If there are multiple appeal processes available: Most states, and most payors when state laws do not apply, allow for two different appeals processes. They are the formal grievance process and an alternative appeals process. The alternative appeals process like Pennsylvania's “Informal/Alternative Disputes Resolution System,” found under ACT 68, allows providers to appeal denials outside the formal grievance process. In these situations HAP may approach denials in the following manner:
   1. HAP can present its case in concert with (sharing data and thoughts), or independently of the providers case under the umbrella of the same denial.
   2. The provider may begin an appeal using the alternative disputes resolution system and HAP may begin its appeal using the formal grievance system. The provider and HAP may share denial data and thoughts as it is received in an effort to improve its chances of winning.
   3. Once the provider has decided to end its appeal utilizing the alternative disputes resolutions system, it can share its denial data with HAP and HAP may begin the formal grievance process.

(20) Member/patient registers at the provider's facility. Patient will sign and return (or give to the provider to return to HAP) the appropriate legal form(s) or use electronic registration such as use of the Internet, with an electronic signature. The forms/computerized authorization form all contain the legal language need to allow HAP to advocate for them (the member). (30) Then, if an authorization or billing problem occurs, (40) the provider's staff will do their job to rectify the authorization, payment or billing problem and in doing so the will have discussions with the insurer (50) in an effort to resolve the problem.

(60) If the discussions between the provider and the payor do not resolve the issue in an acceptable manner, the provider may pass the issue/problem on to HAP. (70) Obtaining authorization, payment, or satisfying the issue for the member and/or provider is now the responsibility of HAP. (80) HAP will use its advocacy methods (as described in FIG. 2) to obtain authorization, payment or to satisfy the problem for the member and/or provider. At the same time, the provider may continue their efforts to obtain payment if they desire.

The advantage to having HAP involved in working with the insurer at the same time the provider does is great, even if HAP's involvement is nothing more than a inquisitory letter. The reason for this is that one of the primary rules of negotiating is to always leave your opponent an out. By letting the payor know that HAP is waiting to get involved, it will cause the payor to satisfy the issues with the provider readily. Another advantage of having HAP involved is the sharing of information. Every time an appeal is filed it is returned with the reason the denial was upheld. When the provider and HAP share that information, they back the MCO into a corner.

### Example of HAP's Involvement:

A 16 year-old anorexic patient was being forced out of the hospital because the MCO determined that it was no longer medically necessary for her to be an in-patient. The attending physician appeal both verbally and written appeal; both appeals were denied.
The family utilized HAP which filed an appeal for the family. Two days later the MCO said that the patient could stay and that all of the patient's bills would be covered. The MCO went on to say that if the doctor had not appealed the decision, the patient would have been responsible for the hospital bill. HAP never heard from the MCO again and did not contact the MCO because there was no point in having the MCO admit that it was HAP's involvement that changed their minds.

### Example of Sharing Denial Information:

A provider appeal an MCO denial. The denial was upheld but the reason given was that the patient's Western Blot test only tested positive for three bands when four are needed to test positive for Lyme disease according to the CDC's guidelines.
HAP then filed an appeal, using the patient's rights. When the appeal was filed, HAP pointed out that in the MCO's letter to the provider, the MCO pointed tot he CDC's guidelines. In turn, HAP pointed out that the CDC's guidelines stated that the Western Blot test may only be used to substantiate the clinical diagnosis of Lyme and cannot be used to rule-out Lyme. In this case, the MCO's reasoning was used against it.

Note: Some states and payors (irrespective of the state law) do not allow the provider and patient to appeal the same denial at the same time. If this is the case, the provider will appeal using the alternative/informal dispute resolution system and HAP will use the patient's rights. If this is still prohibited for some reason, HAP can apply pressure by asking questions and sending supportive documents only to begin its campaign once the provider has terminated or exhausted its appeal.

(90) Was the desired result obtained by HAP? If an acceptable result was obtained then (160) compare the reimbursement form the payor to the contract to ensure proper payment. (165) If the payor's payment is short, then (200) HAP will request the balance be paid by the payor. (170) End of process.

(90) If the desired outcome was not obtained, then refer the matter back to the provider for possible legal remedies. (130) If the provider did not obtain reimbursement, then (170) end of process. (130) If the provider did obtain reimbursement and the settlements not part of a legal settlement, then (160) compare the reimbursement form the payor to the contract to ensure proper payment. (165) If the payor's payment is short, then (200) HAP will request the balance be paid by the payor. (170) End of process.

### Section XI—Medical Producer's

Medical Producers want to sell their products but are, at times, limited or prohibited because of:
(a) The medication is not on the formulary.
(b) The generic drug is on the formulary but the name brand is not.
(c) Insurance will only allow X amount of the drug per day/week/month.
(d) Insurance limitations of tests (i.e. hormone testing)
(e) The product is considered experimental.
   Examples of these situations are:
(a) A doctor prescribes Viagra for impotence. The patient is not able to obtain the medication because the medication is not on the insurance company's formulary.
(b) A doctor prescribes Catapres for high blood pressure. The patient is forced to take the generic brand because Catapres is not on the insurance company's formulary.
(c) a doctor prescribes Interferon 3 times a week for a patient. The patient's insurance company will only allow the medication to be injected 2 times a week.
(d) A patient is suffering from impotence so the doctor prescribes Viagra. While Viagra might allow the patient to engage in intercourse, the true nature of the problem was low testosterone and the doctor could have prescribed Alza's Testoderm (hormone replacement patch) had he/she known. The reason the doctor did not know the problem was because of the low testosterone was because the patient's insurance company doesn't cover the testing for hormone levels.

### How HAP Solves the Problem(s)

Though the provider has been the patient's primary advocate, MCO's have financial incentives for providers not to prescribe treatment/devices/etc. Furthermore, some providers fear advocating too intensely with a payor for fear the payor may cancel the provider's contract or suffer another form of financial loss. To resolve such problems, medical producers can work with HAP in an effort to have the payor cover their products for the patient.

To ensure coverage for their products, a medical producer would provide a mechanism (e.g. a voucher) whereby the patient could contact HAP to obtain coverage for the medical device without the provider's involvement. The mechanism would also include payment to HAP thereby avoiding the need for the patient to pay.

In short, this is a system that medical producers can use to ensure payment for their products without placing the provider at risk with the payor in any manner. This method involves the medical producer providing a system/methodology to providers that allow the provider to encourage appeal a payor's denial yet hide from the potential backlash of a payor.

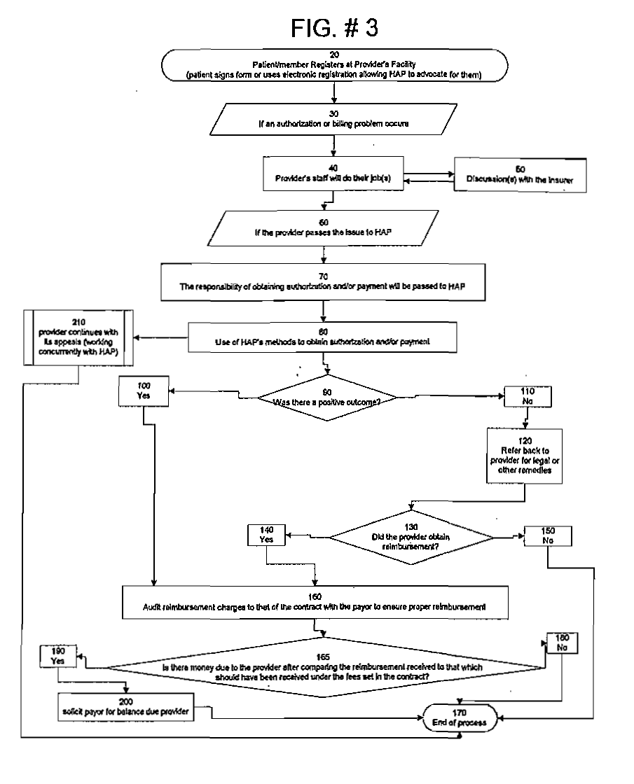

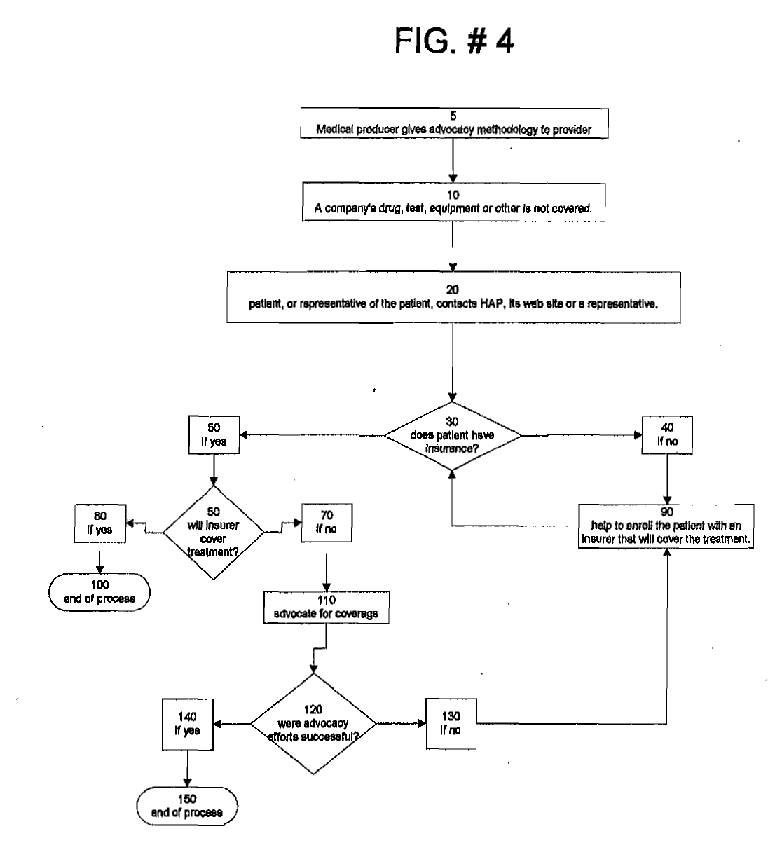

FIG. 4: Medical Producers Process Flow:

(5) The medical producer gives providers a mechanism (e.g. voucher) that the provider can give the patient if/when the medical producer's product is denied by a payor. (10) If a denial is encountered, the provider instructs the patient to contact HAP to (a) educate the patient how to appeal or (b) appeal the denial for the patient.

(20) The member then contacts HAP to resolve the issue. HAP speaks with the member to understand the problem. HAP then asks whether the member would like to handle the problem him/herself of have HAP handle the problem.

If the patient is to be educated how to appeal, HAP will provide the patient with written instructions on how to appeal the denial. If HAP is to appeal the denial, then HAP will use its advocacy method, as described in this patent to advocate for the patient.

Payment for HAP's services will be made by the medical producer. Payment may either be on a per-instance basis (e.g. voucher redemption), annual contract or other.

(30) The patient will then be asked if he/she has insurance. If he/she does not, (90) then HAP will help to obtain insurance for the member. If insurance is not possible, HAP will try to obtain charitable funds to cover the member's needs.

(60) The member has insurance, has insurance then contact the insurer and request coverage. If the insurance company denies coverage, then (110) use HAP's advocacy methods to obtain coverage. If those results were not successful, then (90) enroll the member in another insurance plan. If they were successful, then (150) End of process.

### Section XII—Incentive Buying Plan

As with any business, a company that sells directly to the public seeks to build a bond with its customers to ensure repeat business and word-of-mouth advertising. While a company that sells directly to the public's product line is very successful and sought after, HAP can help to enhance the bond between a company that sells directly to the public and its customers, and increase revenue/sales.

a. Building a Bond

Marketing professionals are always seeking ways to improve customer relationships. The purpose of customer relationships is word-of-mouth advertising, image and repeat business to name a few. The Maternity Care Plan will help develop the bond that will facilitate these desired effects.

It has been HAP's experience that when you help a person in a time of need, or are simply there to answer a question that concerns them, the person will trust you and a bond develops. The bond that HAP develops is so strong that we receive cards, candy and flowers from our clients (sometimes receiving gifts on every holiday). A company that sells directly to the public can avail itself to this bond by offering the Maternity Care Plan resulting in repeat sales, word-of-mouth advertising, etc.

b. Increasing Revenue (sales)

### High Profit Incentives

A company that sells directly to the public's stores carry a large assortment of products. Like any store, some products have a higher profit margin than others. To encourage the customer to purchase the higher profit products, A company that sells directly to the public can offer The Maternity Care Plan as an incentive.

A Maternity Care Plan will be attached to the high profit items that A company that sells directly to the public deems appropriate. Sales people will then point out that if the customer purchases this item they (or the mother to be) will be covered by the Maternity Care Plan. This incentive will help the customer select the high profit products.

### Clearance Products

The traditional approach to handling clearance products is to mark them as “clearance items” and discount the price by 50%+/−. While this method is effective, there is little to no profit made on the products being sold. So, the question is, how do you move merchandise without giving up the profit?

Incentive selling is an approach that works very effectively. The way this works is by placing a Maternity Care Plan on every product that you want to sell. This way, the customer is getting a value-added purchase and A company that sells directly to the public is moving inventory. This is a classic win-win situation.

### Minimum Purchase Incentives

Retail stores are always looking for ways to increase sales. A way to implement that is by offering the Maternity Care Plan on purchases over $50. In this scenario, if a sale is less than $40, a salesperson could simply say, “if you buy the shirt, too, you will automatically receive the Maternity Care Plan; this could save you a lot of money in the long run.”

### Store Selection Incentives

When selling to the public, A company that sells directly to the public is competing against other stores. In this situation, the Maternity Care Plan may be the difference between customers seeking out a company that sells directly to the public store as opposed to a competitor's store.

### Retail Sales

The Maternity Care Plan may also be sold on your stores' counters as a stand-alone product. Simply place it by the cash register and allow it to sell itself. In this situation, A company that sells directly to the public will receive $20 on every plan sold.

The Maternity Care Plan may be sold alone, used as an incentive, or both. If both options are implemented, the customer will automatically see the value when purchasing a product as the retail cost of the plan will be noticeable at the sales counter.

c. Implementation:

### Incentive Selling

HAP will provide A company that sells directly to the public with the pamphlets to be attached to the products. A company that sells directly to the public will then attach the pamphlets to the designated products. The customer will then be responsible for mailing in the enrollment form. Once the enrollment form is received by HAP, the customer/enrollee will be covered for nine months.

### Retail Sales

HAP will provide A company that sells directly to the public with the pamphlets and enrollment forms that will be placed at the sales counter. When a sale is made, A company that sells directly to the public will ring-up the sale and place the enrollment form (after the customer filled it out) in the mail to HAP. HAP will invoice A company that sells directly to the public monthly for the plans sold.

### Section XII—MCO Gap Insurance

MCO Gap Insurance is not like Medigap insurance. Medigap insurance is designed to fill the void between a patient's needs and Medicare's coverage. MCO Gap Insurance, on the other hand, is based on a Managed Care Organization (MCO) denying coverage for treatment.

In today's healthcare system MCO's develop drug formularies and deny coverage for treatment based on their (the insurer's) medical review. In many instances, the MCO's review will disagree with the treating physicians causing a denial of coverage. In these situations, patients may appeal the decision, but if the decision is upheld, they must forego the treatment of medication, or pay for it themselves. This is where MCO Gap insurance comes in.

If a patient is denied coverage for a medically necessary treatment, the MCO Gap Insurance will pay for coverage using a predetermined reimbursement rate.

### MCO Gap Insurance Plan Process Flow:

HAP creates an insurance company that complies with all of the state's regulations. Only people who reside in the state may enroll in the MCO Gap Insurance plan that is being offered in that state. HAP then creates a back account where all funds are pooled.

HAP must create an actuarial table estimating the payout it expects to make based on the number of enrollees. When selling the MCO Gap Insurance Plan, HAP cannot sell more plans than money it has in the bank. Example: if HAP estimates that it will payout $50/person and it only has $100 in the bank account (insurance pool), then is cannot sell more than two plans.

HAP will make enrollment available via providers or by contacting HAP directly. A patient/member, over 18 years of age, may then enroll in the MCO Gap Insurance plan. Enrollment may be via a web site, with third-party verification system or paper form. The enrollment form includes basic contact information and payor information. People without health insurance are not eligible for MCO Gap Insurance plan. Member pays for services via credit card or check.

The member's premiums are placed in to HAP's account where the monies from all enrollees are pooled.

If a member is denied coverage for care by a payor, then the member must go through all stages of the payor's (health insurance) appeals process. If the member, having gone through all levels of appeals, was still denied coverage for treatment then the member must obtain a letter of medical necessity and a prescription for the requested treatment from a physician.

If the requested procedure/treatment has been approved by the FDA for the desired purpose. And it is not considered “elective” under the member's health insurance policy. And it is not covered by a worker's compensation policy, an auto policy or other potential payor/subrogation. Then HAP would pay the provider for the treatment at the primary the insurer's usual and customary rate. The monies used to pay the provider are from the pool of money that is collected from member premiums.

End of process.

### Section XIV—Advocating for Worker's Compensation Cases

The patient/member will sign HAP's authorization form allowing HAP to advocate for him/her. HAP will ask the treating physician for a prescription. In cases where HAP is requesting additional treatment, a new prescription will be requested. If the physician will not write a prescription/new prescription, then HAP will send its member to another physician. The objective in being seen by another physician is to obtain a prescription.

The member will be seen by the new physician and request a prescription/new prescription. Once the member/HAP has obtained a prescription, HAP will present it to the worker's compensation carrier. If the carrier denies treatment, then HAP will send the member out for an independent evaluation by a licensed physician. If the independent evaluation comes back in support of treatment/continuing treatment, then HAP will demand treatment/continued treatment from the carrier.

If the independent opinion does not support HAP's position, then end of process.

### Section XV—The Knowledge Base

The knowledge base is used as a knowledge tool. People utilizing the HAP system may use this tool to gain information on various situations, procedures, facts, and more. In short, it is an expert knowledge base where HAP's experts add information into the knowledge base thereby sharing data.

### Section XVI—HAP's Databases

HAP maintains a membership database; provider and facility database; a payor database; and a general contact database.

The membership database includes general contact information, birth date, health insurance information and more. Each member record has child records (programming term) that enables HAP to track each of the member's problems through conclusion. Each time a member has a problem, HAP creates a new child record to keep vital information and a log of what HAP has done to help resolve the member's issue.

The provider and facility database include general contact information and specific information for each entry. Provider records include a filed for medical school; insurance plans accepted; specialties; hospital privileges; whether or not the provider is in good standing; malpractice suits; board certification(s); a log of the provider's notes and HAP's notes; and more.

The facility records include general contact information; sanctions from the department of health; malpractice suits; a log of the facility's notes and HAP's notes; the insurance the facility accepts; the type of facility; and more.

The payor database include general contact information; comments on the payor and ways to work with them.

The general information database contains contact information for each entry and a log of the interactions with the entity.

Section XVII—HAP Integrating with Defined Contribution Plans and Other Plans that Cause the Employee to Participate in Making their Own Financial Decisions Regarding their Healthcare

HAP integrates very well with defined-contribution health plans. The reason it works so well is because HAP offers the employee (aka the patient) the tools he/she needs to make informed decisions when entering the healthcare system.

While there are many ways that HAP can integrate with a defined-contribution plan, the employer or the employee; the methods for performing the services remain the same. Those services are described in this patent.

### Section XVIII—HAP Providing Quality Assurance for MCOs

HAP integrates well with an MCO because HAP can resolve the MCO's problem(s). The methodology for working with the MCO is simple: The MCO would contract with HAP to provide services to its members. The MCO would inform its members that they may use HAP's services if they have a problem. HAP would track every problem and its resolution. This report would be presented to the NCQA for credentialing purposes.

Once a member has a problem they will contact HAP to resolve the issue. HAP will then resolve the issue for the member using the methodologies as described in this patent. HAP's services will be paid by the MCO.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention.

What is claimed is:

1. A method for assuring payment, in whole or in part, from a third party payor to a provider of healthcare for a patient when the payor denies payment, the method comprising the step of appealing the denial on behalf of the provider using the patient's rights to appeal, after:
a. appealing the denial on behalf of the provider using the provider's rights to appeal; and
b. appealing the denial on behalf of the patient using the patient's rights to appeal.

2. A method for providing healthcare advocacy services to pay for medical care for a patient, comprising the steps of:
a. appealing a third party payor's denial of medical care payment to a healthcare provider on behalf of the patient using the patient's right to appeal;
b. appealing the third party payor's denial of medical care payment to the healthcare provider on behalf of the provider using the provider's right to appeal; and
c. if steps (a) and (b) are unsuccessful, appealing the third party payor's denial of medical care payment to the healthcare provider on behalf of the provider using the patient's right to appeal.

3. The method of claim 2, wherein appealing the denial on behalf of the patient occurs in tandem with appealing the denial on behalf of the provider.

4. The method of claim 2, wherein appealing the denial on behalf of the patient occurs after the provider has exhausted all of the provider's rights to appeal.

5. The method of claim 2, wherein appealing the denial on behalf of the patient occurs although the provider is precluded from billing the patient for the healthcare due to a contract limitation between the payor and the provider.

6. The method of claim 2, wherein an agreement is executed prior to providing the patient's healthcare requiring that, in the event the payor denies payment for a patient's healthcare, the denial will be appealed using the patient's rights to appeal.

7. The method of claim 6, wherein the agreement requires that the denial be appealed using the patient's rights to appeal only after the provider has exhausted all of the provider's rights to appeal.
